(19) United States
(12) Patent Application Publication
(10) Pub. No.: US 2022/0255080 A1
(43) Pub. Date: Aug. 11, 2022

(54) FLAME-RETARDANT HIGH-ELASTICITY POLYMER FOR LITHIUM METAL PROTECTION, LITHIUM SECONDARY BATTERY AND MANUFACTURING METHOD

(71) Applicant: Global Graphene Group, Inc., Dayton, OH (US)

(72) Inventor: Bor Z. Jang, Centerville, OH (US)

(21) Appl. No.: 17/170,287

(22) Filed: Feb. 8, 2021

(51) Int. Cl. H01M 4/60; H01M 10/0525; H01M 4/40; H01M 4/38; H01M 4/62; H01M 10/0567; H01M 10/0562; H01M 10/0565; H01M 4/58; H01M 4/505; H01M 4/525; H01M 4/04

(52) U.S. Cl. CPC H01M 4/606; H01M 10/0525; H01M 4/405; H01M 4/382; H01M 4/624; H01M 10/0567; H01M 4/0435; H01M 10/0565; H01M 4/5815; H01M 4/5805; H01M 4/505; H01M 4/525; H01M 10/0562

(57) ABSTRACT

A lithium secondary battery comprising a cathode, an anode, an elastic polymer protective layer disposed between the cathode and the anode, and a working electrolyte in ionic communication with the anode and the cathode, wherein the protective layer comprises a high-elasticity polymer having a thickness from 2 nm to 200 μm, a lithium ion conductivity of at least 10⁻⁸ S/cm at room temperature, and a fully recoverable tensile elastic strain of at least 5% and wherein the high-elasticity polymer comprises a polymer derived from a monomer selected from the group consisting of phosphates, phosphonates, phosphonic acids, phosphorous acids, phosphites, phosphoric acids, combinations thereof, and combination thereof with phosphazenes and wherein the high-elasticity polymer is impregnated with from 0% to 90% by weight of a lithium salt, a non-aqueous liquid solvent, or a liquid electrolyte comprising a lithium salt dissolved in a non-aqueous liquid solvent.

### FIELD

The present disclosure relates to the field of rechargeable lithium battery, including the lithium-ion battery and the lithium metal battery (a secondary battery that makes use of lithium metal as an anode active material) and a method of manufacturing same.

### BACKGROUND

Lithium-ion and lithium (Li) metal cells (including Lithium-sulfur cell, Li-air cell, etc.) are considered promising power sources for electric vehicle (EV), hybrid electric vehicle (HEV), and portable electronic devices, such as lap-top computers and mobile phones. Lithium metal has the highest capacity (3,861 mAh/g) compared to any other metal or metal-intercalated compound (except Li_{4.4}Si) as an anode active material. Hence, in general, rechargeable Li metal batteries have a significantly higher energy density than lithium-ion batteries.

Historically, rechargeable lithium metal batteries were produced using non-lithiated compounds having high specific capacities, such as TiS₂, MoS₂, MnO₂, CoO₂ and V₂O₅, as the cathode active materials, which were coupled with a lithium metal anode. When the battery was discharged, lithium ions were dissolved from the lithium metal anode and transferred to the cathode through the electrolyte and, thus, the cathode became lithiated. Unfortunately, upon cycling, the lithium metal resulted in the formation of dendrites that ultimately caused unsafe conditions in the battery. As a result, the production of these types of secondary batteries was stopped in the early 1990's giving ways to lithium-ion batteries.

Even now, cycling stability and safety concerns remain the primary factors preventing the further commercialization of Li metal batteries for EV, HEV, and microelectronic device applications. These issues are primarily due to the high tendency for Li to form dendrite structures during repeated charge-discharge cycles or an overcharge, leading to internal electrical shorting and thermal runaway. Many attempts have been made to address the dendrite-related issues, as briefly summarized below:

Fauteux, et al. [D. Fauteux, et al., “Secondary Electrolytic Cell and Electrolytic Process,” U.S. Pat. No. 5,434,021, Jul. 18, 1995] applied to a metal anode a protective surface layer (e.g., a mixture of polynuclear aromatic and polyethylene oxide) that enables transfer of metal ions from the metal anode to the electrolyte and back. The surface layer is also electronically conductive so that the ions will be uniformly attracted back onto the metal anode during electrodeposition (i.e. during battery recharge). Alamgir, et al. [M. Alamgir, et al. “Solid polymer electrolyte batteries containing metallocenes,” U.S. Pat. No. 5,536,599, Jul. 16, 1996] used ferrocenes to prevent chemical overcharge and dendrite formation in a solid polymer electrolyte-based rechargeable battery.

Skotheim [T. A. Skotheim, “Stabilized Anode for Lithium-Polymer Battery,” U.S. Pat. No. 5,648,187 (Jul. 15, 1997); U.S. Pat. No. 5,961,672 (Oct. 5, 1999)] provided a Li metal anode that was stabilized against the dendrite formation by the use of a vacuum-evaporated thin film of a Li ion-conducting polymer interposed between the Li metal anode and the electrolyte. Skotheim, et al. [T. A. Skotheim, et al. “Lithium Anodes for Electrochemical Cells,” U.S. Pat. No. 6,733,924 (May 11, 2004); U.S. Pat. No. 6,797,428 (Sep. 28, 2004); U.S. Pat. No. 6,936,381 (Aug. 30, 2005); and U.S. Pat. No. 7,247,408 (Jul. 24, 2007)] further proposed a multilayer anode structure consisting of a Li metal-based first layer, a second layer of a temporary protective metal (e.g., Cu, Mg, and Al), and a third layer that is composed of at least one layer (typically 2 or more layers) of a single ion-conducting glass, such as lithium silicate and lithium phosphate, or polymer. It is clear that such an anode structure, consisting of at least 3 or 4 layers, is too complex and too costly to make and use.

Protective coatings for Li anodes, such as glassy surface layers of LiI—Li₃PO₄—P₂S₅, may be obtained from plasma assisted deposition [S. J. Visco, et al., “Protective Coatings for Negative Electrodes,” U.S. Pat. No. 6,025,094 (Feb. 15, 2000)]. Complex, multi-layer protective coatings were also proposed by Visco, et al. [S. J. Visco, et al., “Protected Active Metal Electrode and Battery Cell Structures with Non-aqueous Interlayer Architecture,” U.S. Pat. No. 7,282,295 (Oct. 16, 2007); U.S. Pat. No. 7,282,296 (Oct. 16, 2007); and U.S. Pat. No. 7,282,302 (Oct. 16, 2007)].

Despite these earlier efforts, no rechargeable Li metal batteries have yet succeeded in the market place. This is likely due to the notion that these prior art approaches still have major deficiencies. For instance, in several cases, the anode or electrolyte structures are too complex. In others, the materials are too costly or the processes for making these materials are too laborious or difficult. Solid electrolytes typically have a low lithium ion conductivity, are difficult to produce and difficult to implement into a battery.

Furthermore, solid electrolyte, as the sole electrolyte in a cell or as an anode-protecting layer (interposed between the lithium film and another electrolyte) does not have and cannot maintain a good contact with the lithium metal. This significantly reduces the effectiveness of the electrolyte to support dissolution of lithium ions (during battery discharge), transport lithium ions, and allowing the lithium ions to re-deposit back to the lithium anode (during battery recharge). A ceramic separator that is disposed between an anode active material layer (e.g. a graphite-based anode layer or a lithium metal layer) and a cathode active layer suffers from the same problems as well. In addition, a ceramic separator also has a poor contact with the cathode layer if the electrolyte in the cathode layer is a solid electrolyte (e.g., inorganic solid electrolyte).

Another major issue associated with the lithium metal anode is the continuing reactions between electrolyte and lithium metal, leading to repeated formation of “dead lithium-containing species” that cannot be re-deposited back to the anode and become isolated from the anode. These reactions continue to irreversibly consume electrolyte and lithium metal, resulting in rapid capacity decay. In order to compensate for this continuing loss of lithium metal, an excessive amount of lithium metal (3-5 times higher amount than what would be required) is typically implemented at the anode when the battery is made. This adds not only costs but also a significant weight and volume to a battery, reducing the energy density of the battery cell. This important issue has been largely ignored and there has been no plausible solution to this problem in battery industry.

Clearly, an urgent need exists for a simpler, more cost-effective, and easier to implement approach to preventing Li metal dendrite-induced internal short circuit and thermal runaway problems in Li metal batteries, and to reducing or eliminating the detrimental reactions between lithium metal and the electrolyte.

Hence, an object of the present disclosure was to provide a multi-functional separator or an anode-protecting layer to overcome the lithium metal dendrite formation and penetration problems and to prevent continuous electrolyte-lithium reactions in all types of Li metal batteries having a lithium metal anode. A specific object of the present disclosure was to provide a lithium metal cell or a lithium-ion cell that exhibits a safe, high specific capacity, high specific energy, high degree of safety, and a long and stable cycle life.

### SUMMARY

The present disclosure provides a lithium secondary battery comprising a cathode, an anode, an elastic, ion-conducting polymer layer (herein referred to as an “elastic polymer protective layer,” acting as an anode-protecting layer and/or a separator (or ion-conducting membrane) disposed between the cathode and the anode, and a working electrolyte through which lithium ions are transported between the anode and the cathode during the battery charging or discharging step, wherein the elastic and ion-conducting polymer layer comprises a high-elasticity polymer having a thickness from 2 nm to 200 μm (preferably from 10 nm to 20 μm), a lithium ion conductivity from 10⁻⁸ S/cm to 5×10⁻² S/cm at room temperature, and a fully recoverable elastic tensile strain greater than 5% (preferably from 10% to 500%) and further preferably from 30% to 300%) when measured without any additive dispersed therein. The high-elasticity polymer comprises a polymer derived from a monomer selected from the group consisting of phosphates, phosphonates, phosphonic acids, phosphorous acid, phosphites, phosphoric acids, combinations thereof, and combination thereof with phosphazenes and wherein the polymer is impregnated with from 0% to 90% by weight of a lithium salt, a non-aqueous liquid solvent, or a liquid electrolyte comprising a lithium salt dissolved in a non-aqueous liquid solvent. This liquid electrolyte can be the same as or different from the working electrolyte in the cell.

In certain embodiments, the battery has one or more of the following characteristics: (i) the battery is a lithium metal battery and the anode has an anode current collector but initially the anode has no lithium or lithium alloy as an anode active material supported by said anode current collector when the battery is made and prior to a charge or discharge operation of the battery; (ii) the high-elasticity polymer layer serves as a separator and there is no additional separator in the battery; or (iii) the high-elasticity polymer further comprises a flame-retardant additive or particles of an inorganic solid electrolyte.

In some embodiments, the lithium secondary battery further comprises an ion-conducting and electrically insulating separator disposed between the elastic polymer protective layer and the cathode.

In certain embodiments, the polymer derived from phosphoric acid comprises chains of a polyester of phosphoric acid represented by the following structure:

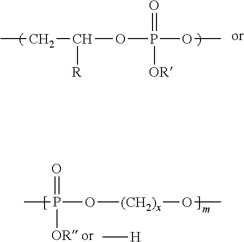

wherein 2≤x≤10, R is selected from Li, H, a methyl, ethyl, propyl, vinyl, allyl, acrylate, phenol, alkyl, aryl, or CH₂Cl, and R′ or R″ is independently selected from Li, CH₃, C₂H₅, n-C₃H₇, i-C₃H₇; n-C₄H₉, CCl₃CH₂, C₆H₅, —OH, —COOH, —O—CH₂CH₂—R′″, an alkyl, or an aryl, where R′″ =—(CH₂)_{y}CH₃ and 0≤y≤10.

In certain embodiments, the monomer (e.g. for polyester of phosphoric acid) is selected from the group consisting of 2-alkoxy (or phenoxy)-2-oxo-1,3,2-dioxaphospholane (I) and 2-alkoxy (or phenoxy)-2-oxo-1,3,2-dioxaphosphorinane (II), derivatives thereof, and combinations thereof:

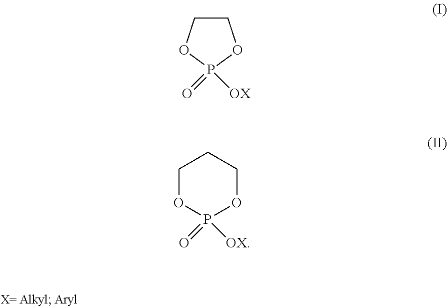

The phosphate, phosphonate, phosphonic acid, or phosphite may be selected from TMP, TEP, TFP, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, and DMMEMP have the following chemical formulae:

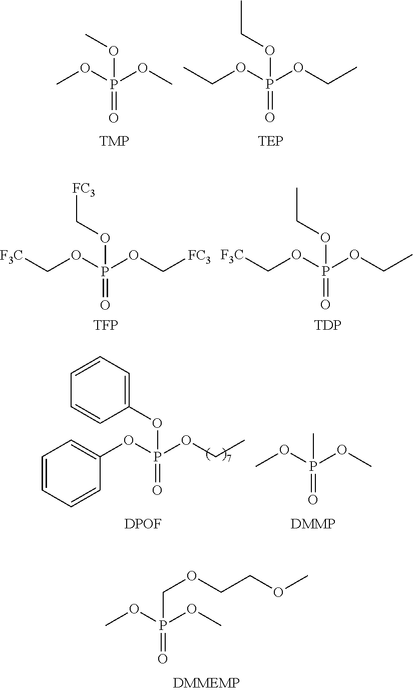

wherein there are functional groups or end groups attached thereto that comprise unsaturation for polymerization.

In certain embodiments, the monomer comprises phosphonate vinyl monomer selected from the group consisting of phosphonate bearing allyl monomers, phosphonate bearing vinyl monomers, phosphonate bearing styrenic monomers, phosphonate bearing (meth)acrylic monomers, vinylphosphonic acids, and combinations thereof. The phosphonate bearing allyl monomer may be selected from a Dialkyl allylphosphonate monomer or Dioxaphosphorinane allyl monomer; the phosphonate bearing vinyl monomers is selected from a Dialkyl vinyl phosphonate monomer or Dialkyl vinyl ether phosphonate monomer; the phosphonate bearing styrenic monomer is selected from α-, β-, or p-vinylbenzyl phosphonate monomers; or the phosphonate bearing (meth)acrylic monomer is selected from a monomer having a phosphonate group linked to the acrylate double bond, a phosphonate groups linked to the ester, or a phosphonate groups linked to the amide.

The optional liquid electrolyte typically comprises a lithium salt dissolved in a non-aqueous solvent (e.g., an organic liquid solvent or an ionic liquid). The lithium salt concentration in the liquid electrolyte solution may be from 0.1 M to 20 M, preferably greater than 1.5 M, more preferably greater than 2.0 M, further more preferably greater than 3.0 M. The total liquid solvent proportion in the elastic polymer protective layer is preferably less than 90% by weight, more preferably less than 50%, further preferably less than 20%, still more preferably less than 10% and most preferably less than 5% by weight.

In certain embodiments, the high-elasticity polymer contains a cross-linked network of a phosphazene compound crosslinked by a crosslinking agent to a degree of crosslinking that imparts an elastic tensile strain from 5% to 500%.

The crosslinking agent may be selected from poly(diethanol) diacrylate, poly(ethyleneglycol)dimethacrylate, poly(diethanol) dimethylacrylate, poly(ethylene glycol) diacrylate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid, glycidyl functions, N,N-Methylenebisacrylamide (MBAAm), Ethylene glycol dimethacrylate (EGDMAAm), isobomyl methacrylate, poly (acrylic acid) (PAA), methyl methacrylate, isobomyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, a chemical derivative thereof, or a combination thereof.

The monomer may be crosslinked by a crosslinking agent that comprises a compound having at least one reactive group selected from a phenylene group, a hydroxyl group, an amino group, an imino group, an amide group, an acrylic amide group, an amine group, an acrylic group, an acrylic ester group, or a mercapto group in the molecule.

In a typical configuration, this elastic polymer protective layer is in ionic contact with both the anode and the cathode and typically in physical contact with an anode active material layer (or an anode current collector) and with a cathode active material layer.

In some embodiments, with this multi-functional elastic polymer protective layer, there is no need to have a separate or additional separator or anode-protecting layer in the battery cell. This multi-functional layer serves not only as a separator that electrically isolates the anode from the cathode but also a lithium metal protection layer (in the cases where lithium metal is the primary anode active material). This layer is elastic, enabling good ionic contact between an anode active layer (or anode current collector) and a cathode active layer, thereby significantly reducing the interfacial impedance.

Alternatively, the lithium secondary battery may further comprise an ion-conducting and electrically insulating separator disposed between the elastic polymer protective layer and the cathode. This separator can be selected from a polymer, ceramic, fibrous, glass, or composite type ion permeable membrane. This high-elasticity polymer enables a good ionic contact between the separator layer and the anode.

In certain embodiments, the anode in the lithium secondary battery has an amount of lithium or lithium alloy as an anode active material supported by an anode current collector.

In certain other embodiments, initially the anode has no lithium or lithium alloy as an anode active material supported by the anode current collector when the battery is made and prior to a charge or discharge operation of the battery. The needed lithium ions are pre-stored in the cathode active material when the battery is made. This configuration is referred to as an anode-less lithium battery.

In certain embodiments, the battery is a lithium-ion battery and the anode has an anode current collector and a layer of an anode active material supported by the anode current collector, which is in physical contact with the elastic flame-retardant composite separator. The anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

The anode current collector may be selected from, for instance, a Cu foil, a Cu-coated polymer film, a sheet of Ni foam, a porous layer of nano-filaments, such as graphene sheets, carbon nanofibers, carbon nano-tubes, etc.

In some embodiments, the cathode comprises particles of a cathode active material and a conductive additive that are dispersed in or bonded by a high-elasticity polymer, which serves as a solid-state electrolyte. This high-elasticity polymer electrolyte in the cathode may comprise at least a crosslinked polymer network of chains derived from at least one phosphazene compound.

This elastic protective polymer layer may also act to provide flame-retardant or fire-resisting capability to the battery since polymers from phosphates, phosphonates, phosphonic acids, phosphorous acid, phosphites, phosphoric acids, combinations and phosphazenes can prevent the anode from initiating a thermal runaway problem. One may choose to add an additional amount of from 0.1% to 70% (preferably from 10% to 50%) by weight of a flame retardant that is dispersed in, dissolved in, or chemically bonded to the high-elasticity polymer. Preferably, the flame retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

In certain embodiments, the elastic polymer composite comprises reactive type flame retardant (flame-retardant group becomes part of the polymer chain structure after polymerization or crosslinking), additive type flame retardant (additive simply dispersed in the polymer matrix), or both types. For instance, the elastic polymer composite may comprise a flame retardant chemical group that is bonded to polysiloxane, which is elastic.

In certain embodiments, the flame retardant additive is in a form of encapsulated particles comprising the additive encapsulated by a shell of coating material that is breakable or meltable when exposed to a temperature higher than a threshold temperature (e.g., flame or fire temperature induced by internal shorting). The encapsulating material is a substantially lithium ion-impermeable and liquid electrolyte-impermeable coating material.

In some embodiments, the high-elasticity polymer further comprises from 0.01% to 95% by weight of an inorganic filler dispersed therein. The inorganic filler may be selected from an oxide, carbide, boride, nitride, sulfide, phosphide, halogen compound, or selenide of a transition metal, Al, Ga, In, Sn, Pb, Sb, B, Si, Ge, Sb, or Bi, a lithiated version thereof, or a combination thereof. The transition metal is selected from Ti, V, Cr, Mn, Fe, Co, Ni, Cu, Zn, Y, Zr, Nb, Mo, Pd, Ag, Cd, La, Ta, W, Pt, Au, Hg, a combination thereof.

The inorganic filler may be selected from an inorganic solid electrolyte material in a fine powder form having a particle size from 2 nm to 30 μm. Preferably, the elastic layer further comprises from 1% to 90% by weight of particles of an inorganic solid electrolyte material dispersed therein wherein the particles have a particle size preferably from 10 nm to 30 μm, more preferably from 50 nm to 1 μm.

The inorganic solid electrolyte material may be selected from an oxide type, sulfide type, hydride type, halide type, borate type, phosphate type, lithium phosphorus oxynitride (UPON), Garnet-type, lithium superionic conductor (LISICON), sodium superionic conductor (NASICON), or a combination thereof.

In the lithium secondary battery, the working electrolyte in the battery is selected from an organic liquid electrolyte, ionic liquid electrolyte, polymer gel electrolyte, solid-state electrolyte, quasi-solid electrolyte having a lithium salt dissolved in an organic or ionic liquid with a lithium salt concentration higher than 2.0 M, hybrid or composite electrolyte, or a combination thereof.

A high-elasticity polymer refers to a polymer, typically a lightly cross-linked polymer, which exhibits an elastic deformation that is at least 5% (preferably at least 10%) when measured under uniaxial tension. In the field of materials science and engineering, the “elastic deformation” is defined as a deformation of a material (when being mechanically stressed) that is essentially fully recoverable upon release of the load and the recovery process is essentially instantaneous (no or little time delay). The elastic deformation is more preferably greater than 10%, even more preferably greater than 30%, further more preferably greater than 50%, and still more preferably greater than 100%. The elasticity of the elastic polymer alone (without any additive dispersed therein) can be as high as 1,000%. However, the elasticity can be significantly reduced if a certain amount of inorganic filler is added into the polymer. Depending upon the type and proportion of the solid electrolyte particles incorporated, the reversible elastic deformation is typically reduced to the range of 5%-500%, more typically 5%-300%.

The high-elasticity polymer may comprise an elastomer that forms a mixture, a copolymer, a semi-interpenetrating network, or a simultaneous interpenetrating network with the high-elasticity polymer, wherein the elastomer is selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastormer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, polyurethane, urethane-urea copolymer, urethane-acrylic copolymer, a copolymer thereof, a sulfonated version thereof, or a combination thereof.

The high-elasticity polymer may further comprise from 0.1% to 50% by weight of a lithium ion-conducting additive, which is different from the inorganic solid electrolyte particles.

In certain embodiments, the anode contains a current collector without a lithium metal or any other anode active material, such as graphite or Si particles, when the battery cell is manufactured. Such a battery cell having an initially lithium metal-free anode is commonly referred to as an “anode-less” lithium battery. The lithium ions that are required for shuttling back and forth between the anode and the cathode are initially stored in the cathode active materials (e.g., Li in LiMn₂O₄ and LiMPO₄, where M=Ni, Co, F, Mn, etc.). During the first battery charge procedure, lithium ions (Li⁺) come out of the cathode active material, move through the electrolyte and then through the presently disclosed elastic and flame retardant composite separator and get deposited on a surface of the anode current collector. As this charging procedure continues, more lithium ions get deposited onto the current collector surface, eventually forming a lithium metal film or coating. The high-elasticity nature of the disclosed separator may be squeezed when the lithium film increases in thickness.

During the subsequent discharge, this lithium film or coating layer decreases in thickness due to dissolution of lithium into the electrolyte to become lithium ions, possibly creating a gap between the current collector and the protective layer if the separator layer were not elastic. Such a gap would make the re-deposition of lithium ions back to the anode impossible during a subsequent recharge procedure. We have observed that the elastic composite separator is capable of expanding or shrinking congruently or conformably with the anode layer. This capability helps to maintain a good contact between the current collector (or the lithium film itself) and the protective layer, enabling the re-deposition of lithium ions without interruption.

In certain embodiments, the high-elasticity polymer further contains a reinforcement material dispersed therein wherein the reinforcement material is selected from a polymer fiber, a glass fiber, a ceramic fiber or nano-flake (e.g. nano clay flakes), or a combination thereof. The reinforcement material preferably has a thickness or diameter less than 100 nm.

The elastic polymer protective layer may further comprise a lithium salt (as a lithium ion-conducting additive) dispersed in the polymer wherein the lithium salt may be preferably selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate(LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, or a combination thereof.

The elastic polymer protective layer preferably has a lithium ion conductivity no less than 10⁻⁵ S/cm, more preferably no less than 10⁻⁴ S/cm, and most preferably no less than 10⁻³ S/cm. Some of the selected polymers exhibit a lithium-ion conductivity greater than 10⁻² S/cm.

In some embodiments, the high-elasticity polymer further comprises a lithium ion-conducting additive dispersed in a high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

In some embodiments, the high-elasticity polymer forms a mixture, blend, semi-IPN, or simultaneous interpenetrating network (SIPN) with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazene, Polyvinyl chloride, Polydimethylsiloxane, poly(vinylidene fluoride)-hexafluoropropylene (PVDF-HFP), a sulfonated derivative thereof, or a combination thereof. Sulfonation is herein found to impart improved lithium ion conductivity to a polymer.

The cathode active material may be selected from an inorganic material, an organic material, a polymeric material, or a combination thereof. The inorganic material may be selected from sulfur, selenium, a metal oxide, metal phosphate, metal silicide, metal selenide (e.g. lithium polyselides for use in a Li—Se cell), metal sulfide (e.g. lithium polysulfide for use in a Li—S cell), or a combination thereof. Preferably, these cathode active materials contain lithium in their structures; otherwise the cathode should contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The cathode active material may preferably comprise lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

The cathode active material is preferably in a form of nano particle (spherical, ellipsoidal, and irregular shape), nano wire, nano fiber, nano tube, nano sheet, nano belt, nano ribbon, nano disc, nano platelet, or nano horn having a thickness or diameter less than 100 nm. These shapes can be collectively referred to as “particles” unless otherwise specified or unless a specific type among the above species is desired. Further preferably, the cathode active material has a dimension less than 50 nm, even more preferably less than 20 nm, and most preferably less than 10 nm. In some embodiments, one particle or a cluster of particles may be coated with or embraced by a layer of carbon disposed between the particle(s) and/or a high-elasticity polymer layer (an encapsulating shell).

The cathode layer may further contain a graphite, graphene, or carbon material mixed with the cathode active material particles. The carbon or graphite material is selected from polymeric carbon, amorphous carbon, chemical vapor deposition carbon, coal tar pitch, petroleum pitch, meso-phase pitch, carbon black, coke, acetylene black, activated carbon, fine expanded graphite particle with a dimension smaller than 100 nm, artificial graphite particle, natural graphite particle, or a combination thereof. Graphene may be selected from pristine graphene, graphene oxide, reduced graphene oxide, graphene fluoride, hydrogenated graphene, nitrogenated graphene, functionalized graphene, etc.

The cathode active material particles may be coated with or embraced by a conductive protective coating, selected from a carbon material, graphene, electronically conductive polymer, conductive metal oxide, or conductive metal coating.

In certain embodiments, the elastic polymer protective layer has two primary surfaces with a first primary surface facing the anode side and a second primary surface opposing or opposite to the first primary surface (facing the cathode side) and wherein the flame-retardant and/or optional solid electrolyte powder has a first concentration at the first surface and a second concentration at the second surface and the first concentration is greater than the second concentration. In other words, there are more flame retardant and/or inorganic particles at anode side of the elastic composite separator layer than the opposite side intended to be facing the cathode. There is a concentration gradient across the thickness of the elastic composite separator layer. The high concentration of the flame retardant and/or inorganic solid electrolyte particles on the anode side (preferably >30% by weight and more preferably >60% by weight) can help stop the penetration of any lithium dendrite, if formed, and help to form a stable artificial solid-electrolyte interphase (SEI). The high concentration of a flame retardant facing the anode side also acts to suppress any internal thermal run-away or fire. Thus, in some embodiments, the elastic composite separator has a gradient concentration of the flame retardant and/or the inorganic solid electrolyte particles across the thickness of the separator.

The present disclosure also provides a process for manufacturing the elastic polymer protective layer, the process comprising (A) dispersing an optional flame retardant additive and/or optional particles of the inorganic solid electrolyte particles in a liquid reactive mass of a precursor to a high-elasticity polymer (a reactive polymer and a crosslinking agent, or a mixture of a monomer/oligomer, an optional catalyst/initiator, and a crosslinking agent) to form a reactive suspension/slurry wherein the monomer, oligomer or reactive polymer is derived from the group consisting of phosphates, phosphonates, phosphonic acids, phosphorous acid, phosphites, phosphoric acids, combinations thereof, and combination thereof with phosphazenes; (B) dispensing and depositing a layer of the liquid reactive mass or suspension/slurry onto a solid substrate surface; and (C) polymerizing and/or curing (crosslinking) the reactive mass to form a layer of high-elasticity polymer. The high-elasticity polymer comprises at least a crosslinked polymer network of chains derived from at least one phosphazene compound.

The solid substrate may be an anode current collector, an anode active material layer, a cathode active material layer, or a solid separator (e.g., a solid ceramic separator). In other words, this elastic polymer protective layer can be directly deposited onto a layer of anode active material, an anode current collector, a layer of cathode active material, or a solid separator. This is achievable because curing of the presently disclosed high-elasticity polymer does not require a high temperature; curing temperature typically being lower than 300° C., more typically lower than 200° C. or even lower than 100° C. This is in stark contrast to the typically 900-1,200° C. required of sintering an inorganic solid electrolyte to form a ceramic separator. In addition, the presently disclosed elastic polymer protective layer is at least as good as a ceramic separator in terms of reducing interfacial impedance and stopping dendrite penetration.

Preferably, the process is a roll-to-roll process wherein step (B) comprises (i) continuously feeding a layer of the solid substrate (e.g. flexible metal film, plastic film, etc.) from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation (e.g. electron beam or gamma radiation) to polymerize and/or crosslink the reactive mass to form a continuous layer or roll of elastic polymer; and (iii) collecting the elastic polymer on a winding roller. This process is conducted in a reel-to-reel manner.

The process may further comprise unwinding the elastic polymer roll or layer from the winding roller and cutting/trimming the roll (or part of the roll) of elastic polymer into one or multiple pieces of elastic polymer protective layers.

The process may further comprise combining an anode, the elastic polymer protective layer, an optional separator, a working electrolyte, and a cathode electrode to form a lithium battery.

The disclosure also provides an elastic and flame retardant composite layer, wherein the elastic and flame retardant composite layer comprises a high-elasticity polymer and from 0.1% to 70% by weight of a flame retardant additive dispersed in, dissolved in, or chemically bonded to the high-elasticity polymer, wherein said elastic composite layer has a thickness from 5 nm to 200 μm and a lithium ion conductivity from 10⁻⁸ S/cm to 5×10⁻² S/cm at room temperature and said high elasticity polymer has a fully recoverable tensile strain from 5% to 1,000% when measured without any additive dispersed therein and wherein the high-elasticity polymer comprises at least a monomer selected from the group consisting of phosphates, phosphonates, phosphonic acids, phosphorous acid, phosphites, phosphoric acids, combinations thereof, and combination thereof with phosphazenes.

Preferably, the flame retardant additive is in a form of encapsulated particles comprising the additive encapsulated by a shell of coating material that is breakable or meltable when exposed to a temperature higher than a threshold temperature (e.g., flame or fire temperature induced by internal shorting). The encapsulating material is a substantially lithium ion-impermeable and liquid electrolyte-impermeable coating material.

Such an elastic, ion-conducting, and flame-retardant composite may be used as a separator, an anode protection layer, or both for a lithium secondary battery.

Preferably, the high-elasticity polymer composite has a lithium ion conductivity from 1×10⁻⁵ S/cm to 5×10⁻² S/cm. In some embodiments, the high-elasticity polymer composite has a recoverable tensile strain from 10% to 300% (more preferably>30%, and further more preferably>50%).

In certain embodiments, some additive, such as particles of a solid inorganic electrolyte, an elastomer (or its precursor), an ion-conductive polymer, a lithium-ion conducting material, a reinforcement material (e.g. high-strength, non-conducting fibers), or a combination thereof may be added into the reactive mass.

The lithium ion-conducting material is dispersed in the high-elasticity polymer and is preferably selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<x≤1, 1≤y≤4.

In some embodiments, the lithium ion-conducting material dispersed in the reactive mass is selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

If desired, the resulting elastic polymer protective layer may be soaked in or impregnated with an organic or ionic liquid electrolyte.

### BRIEF DESCRIPTION OF THE DRAWINGS

FIG. 1 Schematic of a prior art lithium metal battery cell, containing an anode layer (a thin Li foil or Li coating deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2 Schematic of a presently invented lithium metal battery cell (upper diagram) containing an anode current collector (e.g., Cu foil) but no anode active material (when the cell is manufactured or in a fully discharged state), an elastic polymer protective layer (also serving as a separator), and a cathode active material layer, which is composed of particles of a cathode active material, a conductive additive (not shown) and a resin binder (not shown). A cathode current collector supporting the cathode active layer is also shown. The lower diagram shows a thin lithium metal layer deposited between the Cu foil and the elastic composite separator layer when the battery is in a charged state.

FIG. 3(A) Schematic of an elastic polymer protective layer wherein the flame retardant and/or inorganic solid electrolyte particles are uniformly dispersed in a matrix of high-elasticity polymer according to some embodiments of the present disclosure;

FIG. 3(B) Schematic of an elastic polymer protective layer wherein the flame retardant and/or inorganic solid electrolyte particles are preferentially dispersed near one surface (e.g. facing the anode side) of an elastic polymer protective layer; the opposing surface has a lower or zero concentration of the flame retardant and/or inorganic solid electrolyte particles, according to some embodiments of the present disclosure.

FIG. 4 Schematic of a roll-to-roll process for producing rolls of elastic composite separator in a continuous manner.

### DETAILED DESCRIPTION

This disclosure is related to a lithium secondary battery, wherein the working electrolyte is preferably based on an organic electrolyte, a polymer gel electrolyte, an ionic liquid electrolyte, a quasi-solid electrolyte, or a solid-state electrolyte. The shape of a lithium secondary battery can be cylindrical, square, button-like, etc. The present disclosure is not limited to any battery shape or configuration or any type of electrolyte.

The present disclosure provides a lithium secondary battery comprising a cathode, an anode, and an elastic polymer protective layer disposed between the cathode and the anode, and a working electrolyte through which lithium ions are transported between the anode and the cathode during a battery charge or discharge, wherein the elastic polymer protective layer comprises a high-elasticity polymer having a thickness from 2 nm to 200 μm (preferably 5-100 nm if used as an anode-protecting layer; or preferably from 1 to 20 μm if used as a separator), a lithium ion conductivity from 10⁻⁸ S/cm to 5×10⁻² S/cm at room temperature, and a fully recoverable tensile elastic strain from 5% to 1,000% (preferably greater than 10% and further preferably from 30% to 300%) when measured without any additive dispersed therein. The high-elasticity polymer comprises a polymer derived from at least one monomer selected from the group consisting of phosphates, phosphonates, phosphonic acids, phosphorous acid, phosphites, phosphoric acids, combinations thereof, and combination thereof with phosphazenes. The high-elasticity polymer may preferably comprise a cross-linked network of polymer chains crosslinked by a curing/crosslinking agent to a degree of crosslinking that imparts an elastic tensile strain preferably from 5% to 500%.

Many of these monomers are not known to be polymerizable and, if polymerized, the products are not known to be sufficiently elastic to protect the anode materials that can undergo large volume expansion.

The polymer may comprise a polyvinyl phosphonate polymer comprising chains derived from a phosphonate vinyl monomer. The polymer refers to a phosphorus-containing polymer functionalized at the side chain (herein referred to as a polyvinyl phosphonate), instead of that at the main chain or backbone chain (e.g., polyphosphazene having P in the main chain). The polyvinyl phosphonate herein also includes polyvinylphosphonic acid and its various copolymers. The phosphonate vinyl monomer also includes the vinylphosphonic acid monomer.

The phosphonate vinyl monomer may include allyl-type, vinyl-type, styrenic-type and (meth)acrylic-type monomers bearing phosphonate groups (i.e., either mono or bisphosphonate). In certain embodiments, the phosphonate vinyl monomer is selected from the group consisting of phosphonate bearing allyl monomers (e.g., Dialkyl allylphosphonate monomers and Dioxaphosphorinane allyl monomers), phosphonate bearing vinyl monomers (e.g., Dialkyl vinyl phosphonate monomers and Dialkyl vinyl ether phosphonate monomers), phosphonate bearing styrenic monomers (e.g., α-, β-, and p-vinylbenzyl phosphonate monomers), phosphonate bearing (meth)acrylic monomers (e.g., phosphonate groups linked to the acrylate double bond, phosphonate groups linked to the ester, and phosphonate groups linked to the amide), vinylphosphonic acids, and combinations thereof. Examples of Phosphonate bearing (meth)acrylic monomers include α-(dialkylphosphonate) acrylate, β-(dialkylphosphonate) acrylate, dialkylphosphonate (meth)acrylate, and N-(dialkylphosphonate) (meth)acrylamide.

In some embodiments, the monomer is selected from phosphate, alkyl phosphonate, phosphazene, phosphit; e.g., tris(trimethylsilyl) phosphite (TTSPi), alkyl phosphate, triallyl phosphate (TAP), or a combination thereof. The phosphate or alkyl phosphonate may be selected from the following:

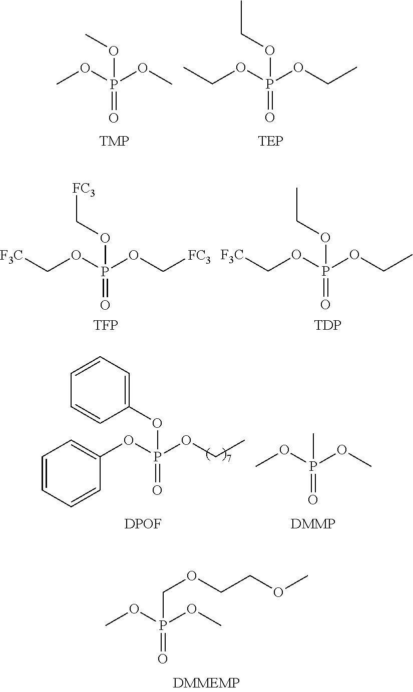

wherein these chemical species comprise end groups or functional groups having unsaturation for polymerization.

For the desired reactive phosphonate vinyl monomers, phosphonate moieties can be readily introduced into vinyl monomers to produce allyl-type, vinyl-type, styrenic-type and (meth)acrylic-type vinyl monomers bearing phosphonate groups (e.g., either mono or bisphosphonate) in the side chain.

First example of phosphonate bearing allyl monomers include Dialkyl allylphosphonate monomers, which can be produced by following Reaction schemes 1-3, shown below:

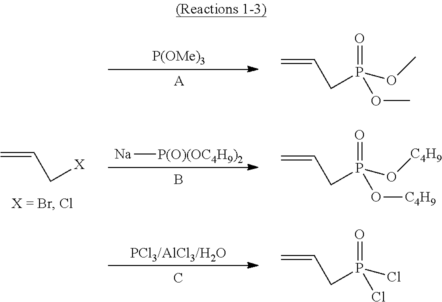

The radical homopolymerization of dialkylphosphonate allyl monomers in the presence of chain transfer agents (CTAs) tends to result in low molecular weight oligomers. In order to be efficiently polymerized, dialkylphosphonate allyl monomers have to be involved in radical copolymerizations in the presence of electron-accepting monomers. For instance, low molecular weight copolymers (about 7 000 g mol:1) can be produced by radical copolymerization of diethyl-1-allyl phosphonate with maleic anhydride. These copolymers are a good choice for use as an electrolyte, which shows excellent flame retardant effects.

As examples of dioxaphosphorinane allyl monomers, dioxaphosphorinanes bearing P-alkyl or P-aryl groups may be synthesized according to the following Reactions 4-5:

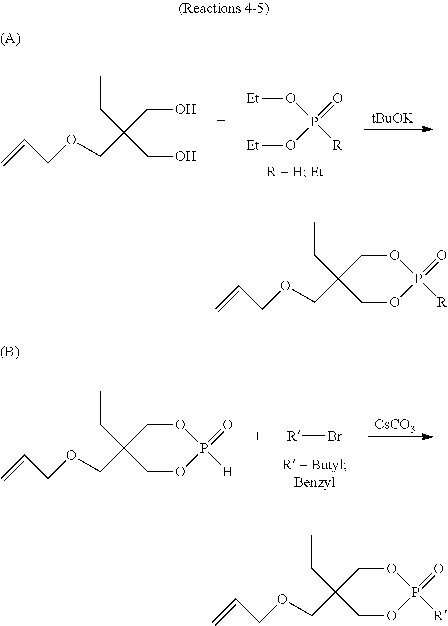

When R is an alkyl or phenyl group, dioxaphosphorinane allyl monomers can undergo radical polymerization that leads to adducts, especially in the presence of chain transfer agents. These oligomers showed a high content of residue from thermal gravimetric analysis, and thus could be employed as an electrolyte ingredient having good flame retardant characteristics. However, when R=H, a high degree of polymerization could be achieved.

Examples of phosphonate bearing vinyl monomers include Dialkyl vinyl phosphonate monomers, which can be produced according to Reactions 6-8.

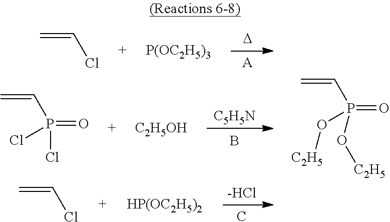

Thiol-ene reaction may be used to polymerize vinyl phosphonate monomers by using CTAs. However, it is more efficient to carry out radical copolymerization of diethyl vinyl phosphonate (DEVP) with styrene carried out at 100° C., which can result in copolymers with a high molecular weight. When DEVP is copolymerized with styrene or acrylonitrile in emulsion, copolymers showed Mw values up to 100, 000 g mol/l.

Dimethyl vinyl phosphonate as examples of Dialkyl vinyl ether phosphonate monomers may be produced according to Reactions 9-10.

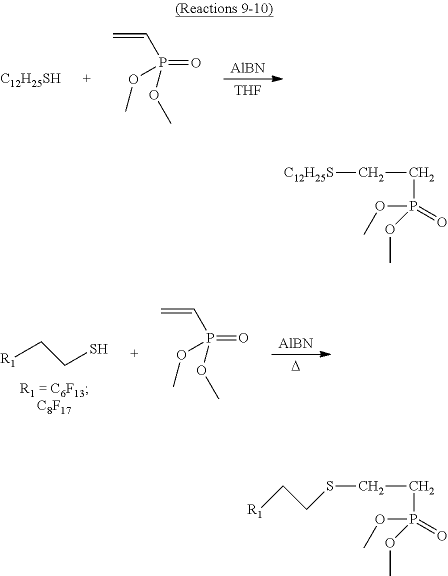

Vinyl ether monomers are good candidates in order to reach high molecular weight polymers either by cationic homopolymerization or by radical copolymerization (when associated with an electron-accepting monomer). The polymerization may be conducted by reaction of chloro ethyl vinyl ether with triethylphosphite.

As examples of phosphonate bearing styrenic monomers, dimethylvinylbenzyl phosphonate can be produced in a high yield from vinylbenzyl chloride (VBC) according to Reactions 11-12 below:

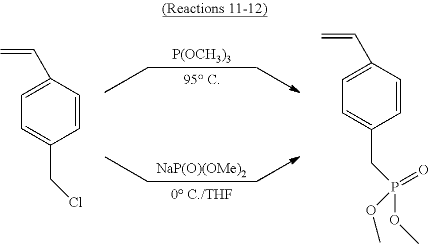

The radical homopolymerization of diethylbenzyl phosphonate (DEVP) may be conducted in the presence of chain transfer agents in order to control both the chain length and the chain-end functionality. The p-Vinylbenzyl phosphonate monomers are used in radical copolymerization as a co-monomer, bringing the specific properties of the phosphonate groups. For instance, DEVP-acrylonitrile copolymers are an effective flame-retardant compounds. The phosphonate moieties will act as a nucleophilic non-volatile phosphorus-containing residue, and will be able to promote cross-linking. Indeed, poly(acrylonitrile) cyclizes at high temperatures and thus becomes more thermally stable; this intracyclization is enhanced by the presence of phosphonic species.

The p-benzyl alkyl phosphonate monomers may participate in radical copolymerization with N-heterocycle monomers, such as 1-vinylimidazole:

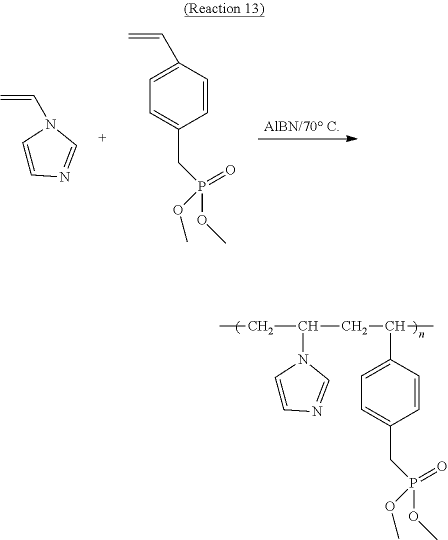

Phosphonate bearing (meth)acrylic monomers exhibit high reactivity in radical polymerization, due to the activation of the (meth)acrylic double bond by the polar substituent. Phosphonate bearing (meth)acrylic monomers can be classified according to either the double bond (acrylic, acrylonitrile, acrylamide, etc.) or to the phosphonate linkage (linked the double bond, to the ester group, etc.).

Phosphonate bearing (meth)acrylic monomers may be obtained according to reactions 14-18:

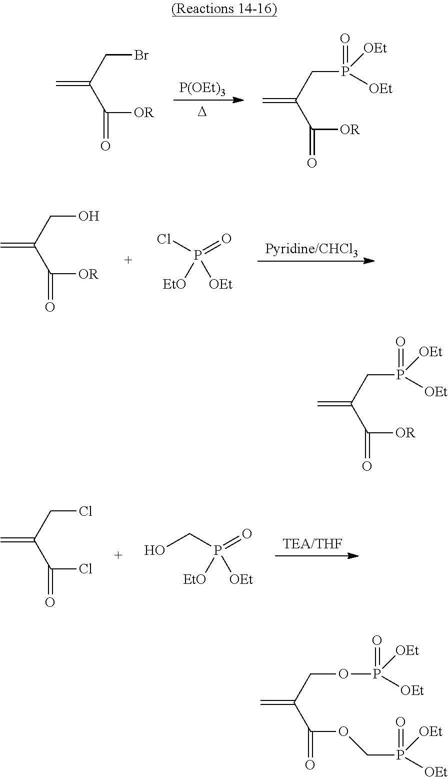

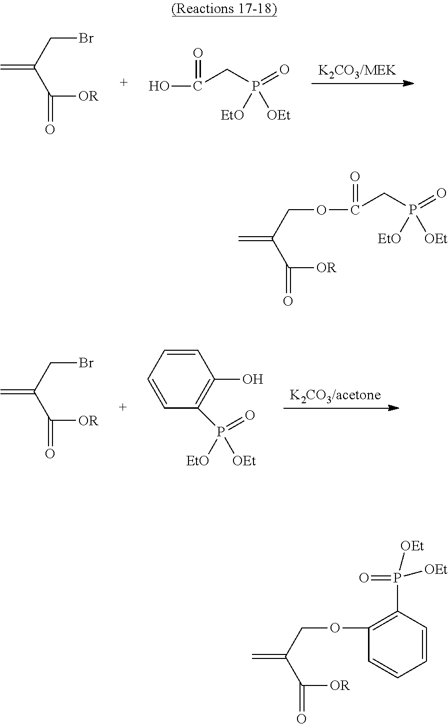

Homopolymerization of β-(dialkylphosphonate) acrylate monomers can be slow but lead to good yields. The reduction of the rate of polymerization may be due to the occurrence of chain transfer processes, which decreases the molecular weight values.

The initiators for anionic or bulk polymerization of these monomers may be selected from n-C₄H₉Li, (C₅H₅)₂Mg, or (i-C₄H₉)₃Al, carbenium salts, and certain lithium salts. The reactions may be conducted at a temperature from −60° C. to 30° C., leading to high molecular weights, typically from 3×10³ to 10⁵. Cationic polymerization may be initiated with CF₃S0₃CH₃, CF₃S0₃C₂H₅, (CF₃SO₂)O, Ph₃C⁺AsF₆⁻, and certain other lithium salts, leading to colored, oily products with number average molecular weights typically up to 10³.

In certain embodiments, the high-elasticity polymer comprises chains of a polyester of phosphoric acid, represented by the following structure (Chemical formula 1 or formula 2):

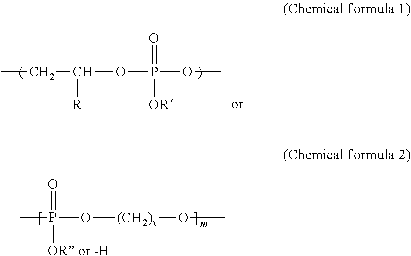

wherein 2≤x≤10, R is selected from Li, H, a methyl, ethyl, propyl, vinyl, allyl, acrylate, alkyl, aryl, or CH₂Cl, and R′ or R″ is independently selected from Li, CH₃, C₂H₅, n-C₃H₇, i-C₃H₇; n-C₄H₉, CCl₃CH₂, C₆H₅, —OH, —COOH, —O—CH₂CH₂—R′″, an alkyl, or an aryl, where R′″=—(CH₂)_{y}CH₃ and 0≤y≤10.

The monomers for the preparation of polyester of phosphoric acid may include the two cyclic phosphate esters—phospholanes (I) and phosphorinanes (II)—five- and six-membered cyclic compounds, respectively, and their derivatives. According to the UPAC nomenclature, the names of these compounds are 2-alkoxy (or phenoxy)-2-oxo-1,3,2-dioxaphospholane (I) and 2-alkoxy (or phenoxy)-2-oxo-1,3,2-dioxaphosphorinane (II).

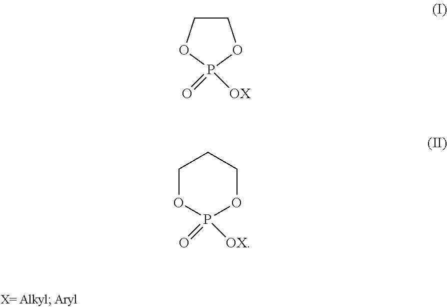

Phosphonate moieties can be readily introduced into vinyl monomers to produce allyl-type, vinyl-type, styrenic-type and (meth)acrylic-type liquid solvents bearing phosphonate groups (e.g., either mono or bisphosphonate). Examples include diethyl vinylphosphonate, dimethyl vinylphosphonate, vinylphosphonic acid, diethyl allyl phosphate, and diethyl allylphosphonate:

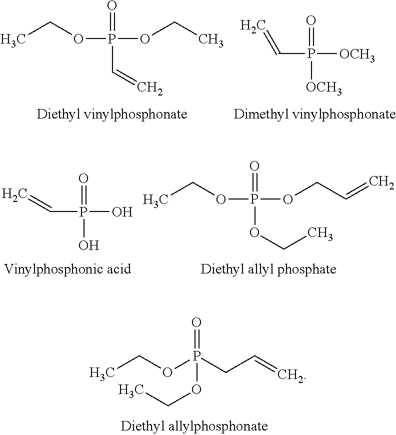

Representative monomers for the preparation of a polyester of phosphoric acid include 2-Alk(aryl)oxy-2-oxo-1,3,2-dioxaphospholans:

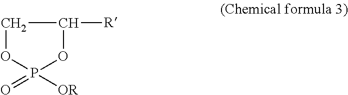

wherein R is selected from Li, H, a methyl, ethyl, propyl, vinyl, allyl, acrylate, alkyl, aryl, or CH₂Cl, and R′ is selected from Li, CH₃, C₂H₅, n-C₃H₇, i-C₃H₇; n-C₄H₉, CCl₃CH₂, C₆H₅, —OH, —COOH, —O—CH₂CH₂—R′″, alkyl, aryl, where R′″=—(CH₂)_{y}CH₃ and 0≤y≤10.

The initiators for anionic or hulk polymerization of these monomers may be selected from n-C₄H₉Li, (C₅H₅)₂Mg, or (i-C₄H₉)₃Al, carbenium salts, and certain lithium salts. The reactions may be conducted at a temperature from −60° C. to 30° C., leading to high molecular weights, typically from 3×10³ to 10⁵. Cationic polymerization may be initiated with CF₃S0₃CH₃, CF₃S0₃C₂H₅, (CF₃SO₂)O, Ph₃C⁺AsF₆⁻, and certain other lithium salts, leading to colored, oily products with number average molecular weights typically up to 10³. The initiator may comprise a lithium salt selected from lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof. In other words, we have surprisingly observed that certain lithium salts actually participate in the polymerization reactions.

The initiator or a co-initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

In addition to an initiator, the reactive monomer solution for the preparation of the presently disclosed high-elasticity polymer may further comprise a curing agent (a crosslinking agent or co-polymerization species) selected from an amide group, such as N,N-dimethylacetamide, N,N-diethylacetamide, N,N-dimethylformamide, N,N-diethylformamide, or a combination thereof. The crosslinking agent may comprise a compound having at least one reactive group selected from a hydroxyl group, an amino group, an imino group, an amide group, an acrylic amide group, an amine group, an acrylic group, an acrylic ester group, or a mercapto group in the molecule. In certain embodiments, the crosslinking agent is selected from poly(diethanol) diacrylate, poly(ethyleneglycol)dimethacrylate, poly(diethanol) dimethylacrylate, or polyethylene glycol) diacrylate.

The crosslinking agent preferably comprises a compound having at least one reactive group selected from a hydroxyl group, an amino group, an imino group, an amide group, an amine group, an acrylic group, or a mercapto group in the molecule. The amine group is preferably selected from Chemical Formula 4:

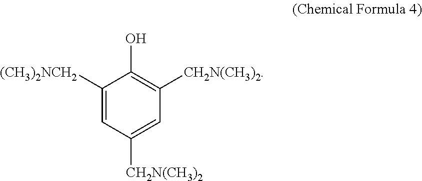

The crosslinking agent is preferably selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobomyl methacrylate, poly (acrylic acid) (PAA), methyl methacrylate, isobomyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

A high-elasticity polymer may comprise an electrolyte solvent (e.g., an organic solvent or ionic liquid), a lithium salt, or both that are dispersed in the polymer chain network (impregnated into or trapped in the polymer chain network). The liquid electrolyte (lithium salt dissolved in a non-aqueous solvent) is preferably from 1% to 95% by weight, preferably from 5% to 50%, based on the total weight of polymer, liquid solvent, and lithium salt combined. The liquid content is further preferably less than 20% and most preferably less than 5%.

Examples of the ionizable lithium salt in the composition for a protective layer according to one embodiment of the present disclosure may include, but are not limited to, any one selected from the group consisting of from lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The liquid electrolyte may comprise a liquid solvent selected from those commonly used in liquid electrolytes for a lithium secondary battery. These include, for example, ether, ester, amide, linear carbonate, cyclic carbonate and the like. They may be used either alone or as a mixture of two or more thereof. Among these, carbonate compounds such as cyclic carbonate, linear carbonate or a mixture thereof may be typically used. Specific examples of the cyclic carbonate compound may comprise any one selected from the group consisting of ethylene carbonate (EC), propylene carbonate (PC), 1,2-butylene carbonate, 2,3-butylene carbonate, 1,2-pentylene carbonate, 2,3-pentylene carbonate, vinylene carbonate, and halides thereof, or a mixture of two or more types thereof. In addition, specific examples of the linear carbonate compound may comprise, but are not limited to, any one selected from the group consisting of dimethyl carbonate (DMC), diethyl carbonate (DEC), dipropyl carbonate (DPC), ethylmethyl carbonate (EMC), methylpropyl carbonate (MPC) and ethylpropyl carbonate (EPC), or a mixture of two or more thereof.

The liquid solvent may be selected from a fluorinated carbonate, hydrofluoroether, fluorinated vinyl carbonate, fluorinated ester, fluorinated vinyl ester, fluorinated vinyl ether, sulfone, sulfide, nitrile, phosphate, phosphite, phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), or a combination thereof. Ionic liquids or organic liquids that are intrinsically flame-retardants are preferred.

For instance, the liquid solvent may be selected from fluorinated solvents, such as fluorinated vinyl carbonates, fluorinated esters, fluorinated vinyl esters, and fluorinated vinyl ethers. Fluorinated vinyl esters include R_{f}CO₂CH═CH₂ and Propenyl Ketones, R_{f}COCH═CHCH₃, where R_{f} is F or any F-containing functional group (e.g., CF₂— and CF₂CF₃—).

Two examples of fluorinated vinyl carbonates are given below:

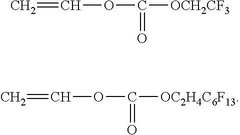

In some embodiments, the fluorinated carbonate is selected from fluoroethylene carbonate (FEC), DFDMEC, FNPEC, hydrofluoro ether (HFE), trifluoro propylene carbonate (FPC), methyl nonafluorobutyl ether (MFE), a combination thereof, wherein the chemical formulae for FEC, DFDMEC, and FNPEC, respectively are shown below:

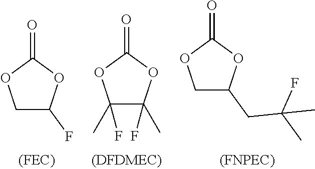

Sulfone-based liquid solvents include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

In certain embodiments, the sulfone-based liquid solvent is selected from TrMS, MTrMS, TMS, or vinyl or double bond-containing variants of TrMS, MTrMS, TMS, EMS, MMES, EMES, EMEES, or a combination thereof; their chemical formulae being given below:

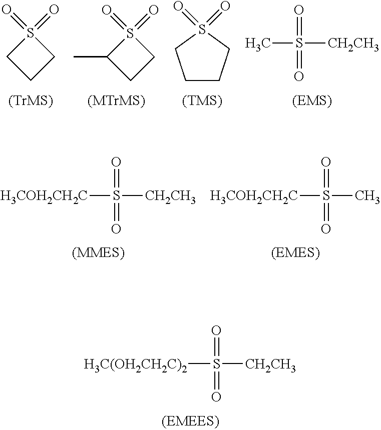

The nitrile may be selected from dinitriles, such as AND, GLN, and SEN, which have the following chemical formulae:

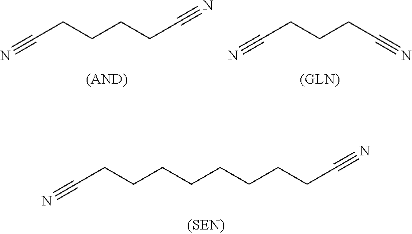 [SMILES: N#CCCCCC#N ; N#CCCCC#N ; N#CCCCCCCCCC#N]

In a typical configuration, the elastic polymer protective layer is in ionic contact with both the anode and the cathode and typically in physical contact with an anode active material layer (or an anode current collector) and with a cathode active material layer.

In certain embodiments, the anode in the lithium secondary battery has an amount of lithium or lithium alloy as an anode active material supported by an anode current collector. In certain other embodiments, initially the anode has no lithium or lithium alloy as an anode active material supported by an anode current collector when the battery is made and prior to a charge or discharge operation of the battery. This latter configuration is referred to as an anode-less lithium battery.

In certain embodiments, the battery is a lithium-ion battery and the anode has an anode current collector and a layer of an anode active material supported by the anode current collector, which is in physical contact with the elastic flame-retardant composite separator. The anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

The current collector may be a Cu foil, a layer of Ni foam, a porous layer of nano-filaments, such as graphene sheets, carbon nanofibers, carbon nano-tubes, etc. forming a 3D interconnected network of electron-conducting pathways.

Preferably and most typically, this elastic polymer protective layer is different in composition than the working electrolyte used in the lithium battery and the elastic composite layer maintains as a discrete layer (not to be dissolved in the electrolyte).

We have discovered that this elastic polymer protective layer provides several unexpected benefits: (a) the formation and penetration of dendrite can be essentially eliminated; (b) uniform deposition of lithium back to the anode side is readily achieved during battery charging; (c) the layer ensures smooth and uninterrupted transport of lithium ions from/to the anode current collector surface (or the lithium film deposited thereon during the battery operations) and through the interface between the current collector (or the lithium film deposited thereon) and the elastic polymer protective layer with minimal interfacial resistance; (d) flame and fire-fighting capability is intrinsically built into the battery; (e) reduced/eliminated electrolyte/lithium metal reactions; (e) reduced interfacial resistance at both the anode side and the cathode side; and (f) cycle stability can be significantly improved and cycle life increased. No additional protective layer for the lithium metal anode is required. The separator itself also plays the role as an anode protective layer.

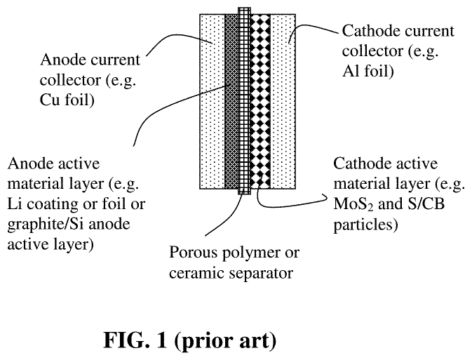

In a conventional lithium metal cell, as illustrated in FIG. 1, the anode active material (lithium) is deposited in a thin film form or a thin foil form directly onto an anode current collector (e.g., a Cu foil) before this anode and a cathode are combined to form a cell. The battery is a lithium metal battery, lithium sulfur battery, lithium-selenium battery, etc. As previously discussed in the Background section, these lithium secondary batteries have the dendrite-induced internal shorting and “dead lithium” issues at the anode.

We have solved these challenging issues that have troubled battery designers and electrochemists alike for more than 30 years by developing and implementing a new elastic polymer protective layer disposed between the anode (an anode current collector or an anode active material layer) and a cathode active material layer. This elastic polymer protective layer comprises a high-elasticity polymer having a recoverable (elastic) tensile strain no less than 5% (preferably no less than 10%, and further preferably from 30% to 500%) under uniaxial tension and a lithium ion conductivity no less than 10⁻⁸ S/cm at room temperature (preferably and more typically from 1×10⁻⁵ S/cm to 5×10⁻² S/cm).

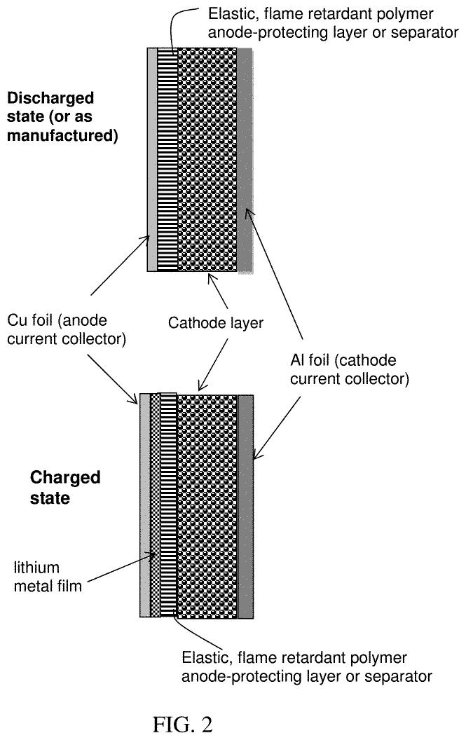

As schematically shown in FIG. 2, one embodiment of the present disclosure is a lithium metal battery or lithium-ion cell containing an anode current collector (e.g., Cu foil), a high-elasticity flame-retardant polymer composite-based protective layer (also serving as a separator), and a cathode active material layer, which is composed of particles of a cathode active material, a conductive additive (not shown) and a resin binder (not shown). A cathode current collector (e.g., Al foil) supporting the cathode active layer is also shown in FIG. 2.

The high-elasticity polymer material refers to a material (polymer or polymer composite) that exhibits an elastic deformation of at least 2% when measured under uniaxial tension. In the field of materials science and engineering, the “elastic deformation” is defined as a deformation of a material (when being mechanically stressed) that is essentially fully recoverable and the recovery is essentially instantaneous upon release of the load. The elastic deformation is preferably greater than 5%, more preferably greater than 10%, further more preferably greater than 30%, and still more preferably greater than 100% (up to 500%).

It may be noted that FIG. 2 shows a lithium battery that initially does not contain a lithium foil or lithium coating at the anode (only an anode current collector, such as a Cu foil or a graphene/CNT mat) when the battery is made. The needed lithium to be bounced back and forth between the anode and the cathode is initially stored in the cathode active material (e.g., lithium vanadium oxide LiₓV₂O₅, instead of vanadium oxide, V₂O₅; or lithium polysulfide, instead of sulfur). During the first charging procedure of such an anode-less lithium battery (e.g., as part of the electrochemical formation process), lithium comes out of the cathode active material, passes through the elastic composite separator and deposits on the anode current collector. The presence of the presently invented high-elasticity polymer protective layer or separator (in good contact with the current collector) enables the uniform deposition of lithium ions on the anode current collector surface. Such a battery configuration avoids the need to have a layer of lithium foil or coating being present during battery fabrication. Bare lithium metal is highly sensitive to air moisture and oxygen and, thus, is more challenging to handle in a real battery manufacturing environment. This strategy of pre-storing lithium in the lithiated (lithium-containing) cathode active materials, such as LiₓV₂O₅ and Li₂Sₓ, makes all the materials safe to handle in a real manufacturing environment. Cathode active materials, such as LiₓV₂O₅ and Li₂Sₓ, are typically not air-sensitive.

As the charging procedure continues, more lithium ions get to deposit onto the anode current collector, forming a lithium metal film or coating. During the subsequent discharge procedure, this lithium film or coating layer decreases in thickness due to dissolution of lithium into the electrolyte to become lithium ions, possibly creating a gap between the current collector and the separator layer if the separator layer were not elastic (e.g., a ceramic separator). Such a gap would make the re-deposition of lithium ions back to the anode impossible during a subsequent recharge procedure. We have observed that the presently invented elastic polymer protective layer is capable of expanding or shrinking congruently or conformably with the anode layer. This capability helps to maintain a good contact between the current collector (or the lithium film subsequently or initially deposited on the current collector surface) and the protective layer, enabling the re-deposition of lithium ions without interruption.

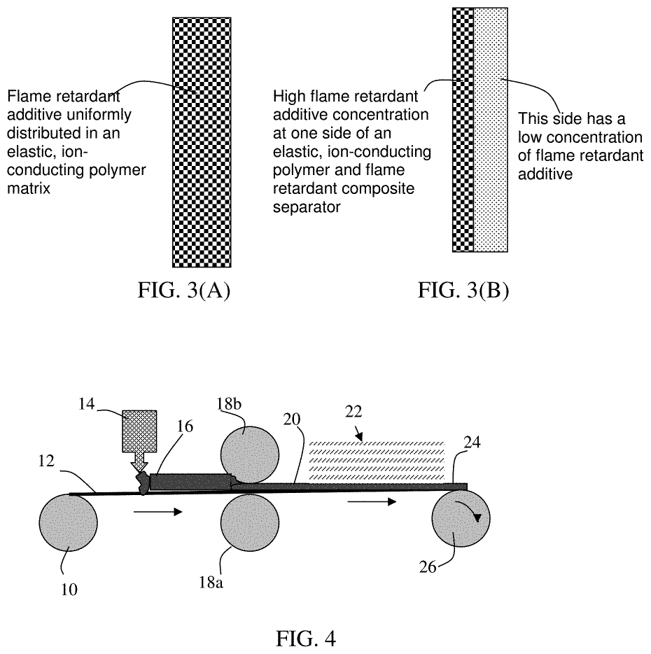

FIG. 3(A) schematically shows an elastic polymer protective layer wherein the flame retardant additive and the optional inorganic solid electrolyte particles are uniformly dispersed in a matrix of an elastic polymer according to some embodiments of the present disclosure. According to some other embodiments of the present disclosure, FIG. 3(B) schematically shows an elastic polymer composite layer wherein the flame retardant additive and/or inorganic solid electrolyte particles are preferentially dispersed near one surface (e.g. facing the anode side) of an elastic composite separator layer; the opposing surface has a lower or zero concentration of the inorganic solid electrolyte particles. This latter structure has the advantages that the high-concentration portion, being strong and rigid, provides a lithium dendrite-stopping capability while other portion of the layer remains highly elastic to maintain good contacts with neighboring layers (e.g., cathode active material layer containing a solid electrolyte on one side and lithium metal on the other) for reduced interfacial impedance. The elastic flame retardant composite separator also acts to retard the flame or fight any internal thermal runaway issue.

It may be noted that the disclosed polymers per se are good flame retardants. However, additional flame-retardant additives may be added to further enhance the battery's ability to inhibit or the internal thermal runaway and combustion processes by interfering with the various mechanisms involved—heating, ignition, and propagation of thermal degradation battery ingredients. The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

There is no limitation on the type of flame retardant that can be physically or chemically incorporated into the elastic polymer. The main families of flame retardants are based on compounds containing: Halogens (Bromine and Chlorine), Phosphorus, Nitrogen, Intumescent Systems, Minerals (based on aluminum and magnesium), and others (e.g., Borax, Sb₂O₃, and nanocomposites). Antimony trioxide is a good choice, but other forms of antimony such as the pentoxide and sodium antimonate may also be used.

One may use the reactive types (being chemically bonded to or becoming part of the polymer structure) and additive types (simply dispersed in the polymer matrix). For instance, reactive polysiloxane can chemically react with EPDM type elastic polymer and become part of the crosslinked network polymer. It may be noted that flame-retarding group modified polysiloxane itself is an elastic polymer composite containing a flame reatardant according to an embodiment of instant disclosure. Both reactive and additive types of flame retardants can be further separated into several different classes:
1) Minerals: Examples include aluminum hydroxide (ATH), magnesium hydroxide (MDH), huntite and hydromagnesite, various hydrates, red phosphorus and boron compounds (e.g. borates).
2) Organo-halogen compounds: This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD).
3) Organophosphorus compounds: This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl) dichloroisopentyldiphosphate (V6).
4) Organic compounds such as carboxylic acid and dicarboxylic acid

The mineral flame retardants mainly act as additive flame retardants and do not become chemically attached to the surrounding system (the polymer). Most of the organohalogen and organophosphate compounds also do not react permanently to attach themselves into the polymer. Certain new non halogenated products, with reactive and non-emissive characteristics have been commercially available as well.

In certain embodiments, the flame retardant additive is in a form of encapsulated particles comprising the additive encapsulated by a shell of coating material that is breakable or meltable when exposed to a temperature higher than a threshold temperature (e.g., flame or fire temperature induced by internal shorting). The encapsulating material is a substantially lithium ion-impermeable and liquid electrolyte-impermeable coating material. The encapsulating or micro-droplet formation processes that can be used to produce protected flame-retardant particles are briefly described below.

Several composite droplet forming processes require the encapsulating polymer or its precursor (monomer or oligomer) to be dissolvable in a solvent. Fortunately, there are a wide variety of polymers or their precursors used herein are soluble in some common solvents or water; water being the preferred liquid solvent. The un-cured polymer or its precursor can be readily dissolved in a common organic solvent or water to form a solution. This solution can then be used to embed, immerse, engulf or encapsulate the solid particles (e.g., flame retardant aluminum hydroxide particles and magnesium hydroxide particles) via several of the micro-droplet-forming methods to be discussed in what follows. Upon formation of the droplets, the polymer matrix is then polymerized and cross-linked.

There are three broad categories of micro-encapsulation methods that can be implemented to produce polymer-encapsulated flame retardant: physical methods, physico-chemical methods, and chemical methods. The physical methods include extrusion and pelletizing, solution dipping and drying, suspension coating or casting on a solid substrate (e.g. slot-die coating, Comma coating, spray-coating) followed by drying and scratching off particles from the substrate, pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

It may be noted that some of these methods (e.g., pan-coating, air-suspension coating, and spray-drying) may be used to coat or encapsulate particles by adjusting the solid content, degree of dispersion, spraying and drying conditions, etc.

The elastic polymer protective layer may comprise an inorganic filler dispersed in the high-elasticity polymer matrix wherein the inorganic filler is preferably selected from an oxide, carbide, boride, nitride, sulfide, phosphide, halogen compound, or selenide of a transition metal, Al, Ga, In, Sn, Pb, Sb, B, Si, Ge, Sb, or Bi, a lithiated version thereof, or a combination thereof. The transition metal is preferably selected from Ti, V, Cr, Mn, Fe, Co, Ni, Cu, Zn, Y, Zr, Nb, Mo, Pd, Ag, Cd, La, Ta, W, Pt, Au, Hg, a combination thereof. Particularly desired metal oxide particles include Al₂O₃ and SiO₂.

In certain preferred embodiments, the inorganic filler comprises fine particles of a solid-state electrolyte made into a powder form. Preferably, the inorganic solid electrolyte material (to be added into the elastic polymer protective layer as a lithium ion conductivity enhancer and a lithium dendrite stopper) is in a fine powder form having a particle size preferably from 10 nm to 30 μm (more preferably from 50 nm to 1 μm). The inorganic solid electrolyte material may be selected from an oxide type (e.g., perovskite-type), sulfide type, hydride type, halide type, borate type, phosphate type, lithium phosphorus oxynitride (LiPON), Garnet-type, lithium superionic conductor (ISICON), sodium superionic conductor (NASICON), or a combination thereof.

The inorganic solid electrolytes that can be incorporated into an elastic polymer protective layer include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in an elastic polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a broad series of garnet-type materials may be used as an additive, including Li₅La₃M₂O₁₂ (M=Nb or Ta), Li₆ALa₂M₇O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The highest reported conductivity in this type of material is 6.9×10⁻⁴ S/cm, which was achieved by doping the Li₂S—SiS₂ system with Li₃PO₄. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer.

These solid electrolyte particles dispersed in an elastic polymer can help stop the penetration of lithium dendrites (if present) and enhance the lithium ion conductivity of certain elastic polymers having an intrinsically low ion conductivity.

Preferably and typically, the high-elasticity polymer has a lithium ion conductivity no less than 10⁻⁵ S/cm, more preferably no less than 10⁻⁴ S/cm, further preferably no less than 10⁻³ S/cm, and most preferably no less than 10⁻² S/cm. The high-elasticity polymer protective layer may be a polymer matrix composite containing from 1% to 95% (preferably 10% to 85%) by weight of lithium ion-conducting solid electrolyte particles dispersed in or bonded by a high-elasticity polymer matrix material.

The high-elasticity polymer should have a high elasticity (elastic deformation strain value>5%). An elastic deformation is a deformation that is fully recoverable and the recovery process is essentially instantaneous (no significant time delay). The high-elasticity polymer can exhibit an elastic deformation from 5% up to 1,000% (10 times of its original length), more typically from 10% to 700%, and further more typically from 50% to 500%, and most typically and desirably from 70% to 300%. It may be noted that although a metal typically has a high ductility (i.e. can be extended to a large extent without breakage), the majority of the deformation is plastic deformation (non-recoverable) and only a small amount of elastic deformation (typically <1% and more typically <0.2%).

Typically, a high-elasticity polymer is originally in a monomer or oligomer state that can be cured to form a cross-linked polymer that is highly elastic. Prior to curing, these polymers or oligomers are soluble in an organic solvent to form a polymer solution. An ion-conducting or flame retardant additive may be added to this solution to form a suspension. This solution or suspension can then be formed into a thin layer of polymer precursor on a surface of an anode current collector. The polymer precursor (oligomer or monomer and initiator) is then polymerized and cured to form a lightly cross-linked polymer. This thin layer of polymer may be tentatively deposited on a solid substrate (e.g., surface of a polymer or glass), dried, and separated from the substrate to become a free-standing polymer layer. This free-standing layer is then laid on a lithium foil/coating or implemented between a lithium film/coating and electrolyte or separator. Polymer layer formation can be accomplished by using one of several procedures well-known in the art; e.g., spraying, spray-painting, printing, coating, extrusion-based film-forming, casting, etc.

Alternatively, the suspension may be directly deposited on a surface of an anode (e.g., a Cu foil or an anode active material layer) or a surface of a cathode layer, followed by curing.

It is essential for these materials to form a lightly cross-linked network of polymer chains. In other words, the network polymer or cross-linked polymer should have a relatively low degree of cross-linking or low cross-link density to impart a high elastic deformation.

The cross-link density of a cross-linked network of polymer chains may be defined as the inverse of the molecular weight between cross-links (Mc). The cross-link density can be determined by the equation, Mc=ρRT/Ge, where Ge is the equilibrium modulus as determined by a temperature sweep in dynamic mechanical analysis, ρ is the physical density, R is the universal gas constant in J/mol*K and T is absolute temperature in K. Once Ge and ρ are determined experimentally, then Mc and the cross-link density can be calculated.

The magnitude of Mc may be normalized by dividing the Mc value by the molecular weight of the characteristic repeat unit in the cross-link chain or chain linkage to obtain a number, Nc, which is the number of repeating units between two cross-link points. We have found that the elastic deformation strain correlates very well with Mc and Nc. The elasticity of a cross-linked polymer derives from a large number of repeating units (large Nc) between cross-links. The repeating units can assume a more relax conformation (e.g. random coil) when the polymer is not stressed. However, when the polymer is mechanically stressed, the linkage chain uncoils or gets stretched to provide a large deformation. A long chain linkage between cross-link points (larger Nc) enables a larger elastic deformation. Upon release of the load, the linkage chain returns to the more relaxed or coiled state. During mechanical loading of a polymer, the cross-links prevent slippage of chains that otherwise form plastic deformation (non-recoverable).

Preferably, the Nc value in a high-elasticity polymer is greater than 5, more preferably greater than 10, further more preferably greater than 100, and even more preferably greater than 200. These Nc values can be readily controlled and varied to achieve different elastic deformation values by using different cross-linking agents with different functionalities, and by designing the polymerization and cross-linking reactions to proceed at different temperatures for different periods of time.

Alternatively, Mooney-Rilvin method may be used to determine the degree of cross-linking. Crosslinking also can be measured by swelling experiments. In a swelling experiment, the crosslinked sample is placed into a good solvent for the corresponding linear polymer at a specific temperature, and either the change in mass or the change in volume is measured. The higher the degree of crosslinking, the less swelling is attainable. Based on the degree of swelling, the Flory Interaction Parameter (which relates the solvent interaction with the sample, Flory Huggins Eq.), and the density of the solvent, the theoretical degree of crosslinking can be calculated according to Flory's Network Theory. The Flory-Rehner Equation can be useful in the determination of cross-linking.

The high-elasticity polymer may contain a simultaneous interpenetrating network (SPIN) polymer, wherein two cross-linking chains intertwine with each other, or a semi-interpenetrating network polymer (semi-IPN), which contains a cross-linked polymer and a linear polymer.

The aforementioned high-elasticity polymers may be used alone to protect the lithium foil/coating layer at the anode. Alternatively, the high-elasticity polymer can be mixed with a broad array of elastomers, electrically conducting polymers, lithium ion-conducting materials, and/or strengthening materials (e.g., carbon nanotube, carbon nano-fiber, or graphene sheets).

A broad array of elastomers can be mixed with a high-elasticity polymer to form a blend, co-polymer, or interpenetrating network that encapsulates the cathode active material particles. The elastomeric material may be selected from natural polyisoprene (e.g. cis-1,4-polyisoprene natural rubber (NR) and trans-1,4-polyisoprene gutta-percha), synthetic polyisoprene (IR for isoprene rubber), polybutadiene (BR for butadiene rubber), chloroprene rubber (CR), polychloroprene (e.g. Neoprene, Baypren etc.), butyl rubber (copolymer of isobutylene and isoprene, IIR), including halogenated butyl rubbers (chloro butyl rubber (CIIR) and bromo butyl rubber (BIIR), styrene-butadiene rubber (copolymer of styrene and butadiene, SBR), nitrile rubber (copolymer of butadiene and acrylonitrile, NBR), EPM (ethylene propylene rubber, a copolymer of ethylene and propylene), EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM; such as Viton, Tecnoflon, Fluorel, Aflas and Dai-El), perfluoroelastomers (FFKM: Tecnoflon PFR, Kalrez, Chemraz, Perlast), polyether block amides (PEBA), chlorosulfonated polyethylene (CSM; e.g. Hypalon), and ethylene-vinyl acetate (EVA), thermoplastic elastomers (TPE), protein resilin, protein elastin, ethylene oxide-epichlorohydrin copolymer, polyurethane, urethane-urea copolymer, and combinations thereof.

The urethane-urea copolymer film usually consists of two types of domains, soft domains and hard ones. Entangled linear backbone chains consisting of poly (tetramethylene ether) glycol (PTMEG) units constitute the soft domains, while repeated methylene diphenyl diisocyanate (MDI) and ethylene diamine (EDA) units constitute the hard domains. The lithium ion-conducting additive can be incorporated in the soft domains or other more amorphous zones.

In some embodiments, a high-elasticity polymer can form a polymer matrix composite containing a lithium ion-conducting additive dispersed in the high-elasticity polymer matrix material, wherein the lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0<s≤1, 1≤y≤4.

In some embodiments, the high-elasticity polymer can be mixed with a lithium ion-conducting additive, which contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

In some embodiments, the high-elasticity polymer may form a mixture, co-polymer, semi-interpenetrating network, or simultaneous interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazene, Polyvinyl chloride, Polydimethylsiloxane, poly(vinylidene fluoride)-hexafluoropropylene (PVDF-HFP), a derivative thereof (e.g. sulfonated versions), or a combination thereof.

The cathode active material may be selected from an inorganic material, an organic material, a polymeric material, or a combination thereof. The inorganic material may be selected from sulfur, selenium, a metal oxide, metal phosphate, metal silicide, metal selenide (e.g. lithium polyselides for use in a Li—Se cell), metal sulfide (e.g. lithium polysulfide for use in a Li—S cell), or a combination thereof. Preferably, these cathode active materials contain lithium in their structures; otherwise the cathode should contain a lithium source.

The inorganic cathode active material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The cathode active material layer may contain a metal oxide containing vanadium oxide selected from the group consisting of LiₓVO₂, LiₓV₂O₅, LiₓV₃O₈, LiₓV₃O₇, LiₓV₄O₉, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The working electrolyte used in the lithium battery may be a liquid electrolyte, polymer gel electrolyte, solid-state electrolyte (including solid polymer electrolyte, inorganic electrolyte, and composite electrolyte), quasi-solid electrolyte, ionic liquid electrolyte.

The liquid electrolyte or polymer gel electrolyte typically comprises a lithium salt dissolved in an organic solvent or ionic liquid solvent. There is no particular restriction on the types of lithium salt or solvent that can be used in practicing the present disclosures. Some particularly useful lithium salts are lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

There are a wide variety of processes that can be used to produce layers of elastic polymer protective layers. These include coating, casting, painting, spraying (e.g., ultrasonic spraying), spray coating, printing (screen printing, 3D printing, etc.), tape casting, etc.

In certain embodiments, the process for manufacturing elastic polymer protective layers comprises (A) dispersing the optional flame retardant additive and optional particles of the inorganic solid electrolyte particles in a liquid reactive mass of an elastic polymer precursor (e.g., a monomer selected from the group consisting of phosphates, phosphonates, phosphonic acids, phosphorous acid, phosphites, phosphoric acids, combinations thereof, and combination thereof with phosphazenes) to form a slurry; (B) dispensing and depositing a layer of the liquid reactive mass or slurry onto a solid substrate surface; and (C) polymerizing and/or curing the reactive mass to form a layer of elastic polymer.

The solid substrate may be an anode current collector, an anode active material layer, or a cathode active material layer. In other words, this elastic composite separator can be directly deposited onto a layer of anode active material, an anode current collector, or a layer of cathode active material. This is achievable because curing of the high-elasticity polymer does not require a high temperature; curing temperature typically lower than 300° C. or even lower than 100° C. This is in stark contrast to the typically 900-1,200° C. required of sintering an inorganic solid electrolyte to form a ceramic separator. In addition, the presently disclosed elastic separator is at least as good as a ceramic separator in terms of reducing interfacial impedance and stopping dendrite penetration.

Preferably, the process is a roll-to-roll process wherein step (B) comprises (i) continuously feeding a layer of the solid substrate (e.g. flexible metal film, plastic film, etc.)

from a feeder roller to a dispensing zone where the reactive mass is dispensed and deposited onto the solid substrate to form a continuous layer of the reactive mass; (ii) moving the layer of the reactive mass into a reacting zone where the reactive mass is exposed to heat, ultraviolet (UV) light, or high-energy radiation to polymerize and/or cure the reactive mass to form a continuous layer of elastic polymer; and (iii) collecting the elastic polymer on a winding roller. This process is conducted in a reel-to-reel manner.

In certain embodiments, as illustrated in FIG. 4, the roll-to-roll process may begin with continuously feeding a solid substrate layer 12 (e.g., PET film) from a feeder roller 10. A dispensing device 14 is operated to dispense and deposit a reactive mass 16 (e.g., reactive slurry) onto the solid substrate layer 12, which is driven toward a pair of rollers (18a, 18b). These rollers are an example of a provision to regulate or control the thickness of the reactive mass 20. The reactive mass 20, supported on the solid substrate, is driven to move through a reacting zone 22 which is provided with a curing means (heat, UV, high energy radiation, etc.). The partially or fully cured polymer composite 24 is collected on a winding roller 26. One may unwind the roll at a later stage.

The process may further comprise cutting and trimming the layer of elastic polymer into one or multiple pieces of elastic polymer protective layers.

The process may further comprise combining an anode, the elastic polymer protective layer, an electrolyte, and a cathode electrode to form a lithium battery.

The lithium battery may be a lithium metal battery, lithium-ion battery, lithium-sulfur battery, lithium-selenium battery, lithium-air battery, etc. The cathode active material in the lithium-sulfur battery may comprise sulfur or lithium polysulfide.

### EXAMPLE 1

### Anode protecting polymers from vinylphosphonic acid (VPA) and triethylene glycol dimethacrylate (TEGDA) or acrylic acid (AA)

The free radical polymerization of acrylic acid (AA) with vinylphosphonic acid (VPA) can be catalyzed with benzoyl peroxide as the initiator. In a vessel provided with a reflux condenser, 150 parts vinylphosphonic acid were dissolved in 150 parts isopropanol and heated for 5 hours at 90° C. together with 0.75 parts benzoyl peroxide and 20 parts of lithium bis(oxalato)borate (LiBOB). A very viscous clear solution of polyvinylphosphonic acid was obtained. On a separate basis, a similar reactive mixture was added with a desirable amount (e.g., 10-50 parts) of AA or TEGDA as a co-monomer. The solutions were separately cast onto a glass surface and cured in a vacuum oven at 90° C. for 5 hours to obtain polymer layers.

In a separate experiment, vinylphosphonic acid was heated to >45° C. (melting point of VPA=36° C.), which was added with benzoyl peroxide, LiBOB. After rigorous stirring, the resulting paste was cast onto a glass surface and cured at 90° C. for 5 hours to form a layer for use in tensile testing. Several tensile testing specimens were cut from each polymer film and tested with a universal testing machine. The representative tensile stress-strain curves indicate that this series of network polymers have an elastic deformation from approximately 35% to 224%.

A protective layer was then laminated between a Cu foil and a separator for use in an anode-less lithium battery (initially the cell being lithium-free) containing a NCM-532 cathode. Another protective layer was disposed between a Cu foil-supported lithium metal foil and a separator in a lithium-sulfur cell.

### EXAMPLE 2

### Anode Protecting Layer from Free Radical Polymerization of Diisopropyl-p-vinylbenzyl Phosphonate and 1-Vinylimidazole

Copolymers of diisopropyl-p-vinylbenzyl phosphonate (DIPVBP) and 1-vinylimidazole (1VI) were prepared by free radical polymerization. First, Diisopropyl-p-vinylbenzyl phosphonate was synthesized by taking the following procedure: Potassium tert-butoxide (8.16 g, 72.7 mmol) in dry THF (40 mL) was added dropwise into stirred solution of diisopropyl phosphate (14.19 g, 85.4 mmol) and p-vinylbenzyl chloride (10.72 g, 70.25 mmol) in THF within 2 h. The reaction was maintained at room temperature throughout by occasional cooling with an ice bath. The mixture was under stirring for another hour at room temperature and then filtered, diluted with diethyl ether (200 mL), and washed with water (100 mL) three times. The organic component was then dried over sodium sulfate. The raw product was then purified by flash column chromatography on silica. Residual vinylbenzyl chloride was eluted with toluene, and subsequently the product was washed off with ethyl acetate to yield colorless oil.

Synthesis of Poly(diisopropyl-p-vinylbenzyl phosphonate-co-1-vinylimidazole) was conducted with various feed ratios of 1VI and DIPVBP in toluene solution at 70° C. with AIBN as initiator. Specifically, the copolymers (with feed ratios of monomers from 1/9 to 9/1) were synthesized by dissolving 1VI and DIPVBP in toluene. Approximately 1% by weight of AIBN (relative to the total monomer weight) in toluene was added into the solution. The reaction mixture was stirred under a nitrogen atmosphere at 70° C. for 2 hours to obtain the copolymer, which was cast on a glass surface. The polymerization was illustrated in Reaction 13 presented in an earlier section.

The homopolymer of DIPVBP was synthesized by free radical polymerization in toluene under similar conditions to the copolymers.

In an additional experiment, poly(diisopropyl-p-vinylbenzyl phosphonate-co-1-vinylimidazole) prepared above was dissolved in ethanol and reacted with excess HCl aqueous solution (10 mol/L) at 100° C. for 24 h, and the corresponding poly(vinylbenzylphosphonic acid-co-1-vinylimidazole) was obtained after purification. This co-polymer was cast on a glass surface to obtain a layer for tensile testing and lithium ion conductivity measurement.

The room temperature lithium-ion conductivity values of the poly(diisopropyl-p-vinylbenzyl phosphonate) homo-polymer, the poly(diisopropyl-p-vinylbenzyl phosphonate-co-1-vinylimidazole) copolymer, and the poly(vinylbenzylphosphonic acid-co-1-vinylimidazole) copolymer (each containing approximately 5% by weight lithium salt) were approximately 2.5×10⁻⁵ S/cm, 7.4×10⁻⁴ S/cm, and 5.6×10⁻³ S/cm, respectively. The polymers are flame resistant and relatively safe, being capable of stopping lithium dendrite formation or penetration.

Two types of battery cells were studied in this example: a lithium/NCM-811 cell (initially the cell being lithium-free at the anode side) and a lithium/NCA cathode (initially lithium-free at the anode). For both types of battery cells, the high-elasticity serves as a dual role of an anode protecting layer and a separator or as an anode protecting layer only (having an additional separator). In either configuration, the high-elasticity polymer layer is in physical contact with either an anode current collector surface or an anode active material layer.

### EXAMPLE 3

### Anode protective layers based on homo-polymers and copolymers from dimethyl(methacryloyloxy)-methyl phosphonate (MAPC1)

A phosphonated methacrylate, namely dimethyl(methacryloyloxy)-methyl phosphonate (MAPC1), was synthesized using paraformaldehyde and potassium carbonate. This began with the synthesis of Dimethyl-a-Hydroxymethylphosphonate by following the procedure below: Ten grams (0.09 mol) of dimethyl hydrogenophosphonate, 2.73 g (0.09 mol) of paraformaldehyde, 30 mL of methanol, and 0.62 g of anhydrous K₂CO₃ were introduced in a two-necked flask equipped with a condenser. The solution was vigorously stirred under methanol refluxing for 2 h. Dimethyl-a-hydroxymethylphosphonate was obtained under high vacuum with 98% yield.

For the synthesis of Dimethyl(methacryloxy)methyl Phosphonate (MAPC1), ten grains (0.071 mol) of dimethyl-a-hydroxymethylphosphonate, 6.15 g (0.071 mol) of methacrylic acid, and 30 mL of chloroform were introduced in a two-necked flask equipped with a condenser. Temperature was dropped until 0° C. and, after degasing, 14.73 g (0.0071 mol) of dicyclohexylcarbodiimide (DCCI), 0.872 g (0.0071 mol) of N,N-dimethyl-4-aminopyridine (DMAP) were added in a dropwise manner. The solution was vigorously stirred at room temperature for 2 h. After filtration, MAPC1 is obtained by distillation under high vacuum (100° C. with 2×10⁻² mmHg) with 90% yield.

The synthesis of Methyl(methacryloxy)methyl Phosphonic Hemi-Acid MAPC1(OH) was conducted in the following manner: Four grams (0.019 mol) of MAPC1, 2 g (0.019 mol) of NaBr, and 20 mL of methylethylketone were introduced in a two-necked flask equipped with a condenser and with a magnetic stirrer. The reaction mixture was heated under reflux with stirring for 13 h and at room temperature for 4 h. The sodium salt was precipitated, filtered, and washed several times with acetone to remove residues. The white powder was dried under high vacuum for 2 h (88% yield). The salt was solubilized in methanol and passed through a column filled with sulfonic acid resin. The column was washed with methanol until reaching neutral pH, and the final MAPC1(OH) was obtained with 97% yield.

Homo polymerization and copolymerization of MAPC1 and MAPC1(OH) with MMA were conducted in a three-necked flask equipped with a condenser, a septum cap (to be able to take aliquots), and a magnetic stirrer in acetonitrile refluxing and with AIBN as initiator. Radical polymerization of MAPC1 was performed at 80° C. in acetonitrile, initiated with AIBN (1 mol %) for 2 h, and the MAPC1 conversion was monitored over time. Radical copolymerizations of both MAPC1 and MAPC1(OH) with MMA were then carried out in acetonitrile at 80° C. initiated by AIBN (1 mol %). Polymerizing solutions were cast onto Cu foil surfaces and glass surfaces to form layers prior to completion of the polymerization reactions.

The room temperature lithium-ion conductivities of these polymers were approximately from 4.5×10⁻⁶ S/cm to 1.3×10⁻⁴ S/cm. The elasticity value of these polymers, upon irradiation to electron beam to generate a low degree of crosslinking was from 25% to 120%.

Three types of battery cells were studied in this example: a lithium/NCM-811 cell (initially the cell being lithium-free), a Si/NCM-811 cell, and a lithium-sulfur cell.

### EXAMPLE 4

### Diethyl Vinylphosphonate and Diisopropyl Vinylphosphonate Polymers for Anode Protection

Both diethyl vinylphosphonate and diisopropyl vinylphosphonate were polymerized by a peroxide initiator (di-tert-butyl peroxide), along with LiBF₄, to clear, light-yellow polymers of low molecular weight. In a typical procedure, either diethyl vinylphosphonate or diisopropyl vinylphosphonate (being a liquid at room temperature) is added with di-tert-butyl peroxide (0.5-2% by weight) and LiBF₄ (5-10% by weight) to form a reactive solution. Si nanowires and nano particles were separately dispersed into the reactive solution. The resulting suspension was heated to 45° C. allowing bulk polymerization to proceed for 2-12 hours. Subsequently, the suspension was spray-dried to form composite particulates.

Additionally, layers of diethyl vinylphosphonate and diisopropyl vinylphosphonate polymer electrolytes were cast on glass surfaces and polymerized under comparable conditions. The lithium ion conductivity of these materials was measured. The lithium ion conductivity of diethyl vinylphosphonate derived polymers was found to be in the range from 5.4×10⁻⁵ S/cm-7.3×10⁻⁴ S/cm and that of diisopropyl vinylphosphonate polymers in the range from 6.6×10⁻⁵ S/cm-8.4×10⁻⁴ S/cm. Both are highly flame resistant.

Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the cells containing a protective layer perform very well in terms of cycling stability and the energy storage capacity and yet these cells are flame resistant and relatively safe.

### EXAMPLE 5

### Curing of Cyclic Esters of Phosphoric Acids

As selected examples of polymers from phosphates, five-membered cyclic esters of phosphoric acid of the general formula, —CH₇CH(R)OP(O)—(OR′)O—, were polymerized to solid, soluble polymers of high molecular weight by using n-C₄H₉Li, (C₅H₅)₂Mg, or (i-C₄H₉)₃Al as initiators. The resulting polymers have a repeating unit as follows:

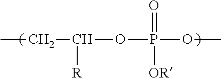

where R is H, with R′=CH₃, C₂H₅, n-C₃H₇; n-C₄H₉, CCl₃CH₂, or C₆H₅, or R is CH₂Cl and R′ is C₂H₅. The polymers typically have Mₙ=10⁴-10⁵.

In a representative procedure, initiators n-C₄H₉Li (0.5% by weight) and 5% lithium bis(oxalato)borate (LiBOB) as a lithium salt were mixed with 2-alkoxy-2-oxo-1,3,2-dioxaphospholan (R′=H in the following chemical formula):

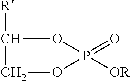

Temperature or a second solvent may be used to adjust the viscosity of the reactant mixture, where necessary. The solution was cast as thin films 1-10 μm, which were allowed to undergo the anionic polymerization at room temperature (or lower) overnight to form a polymer solid. The room temperature lithium ion conductivities of this series of solid polymers are in the range from 2.5×10⁻⁵ S/cm-1.6×10⁻³ S/cm.

Separately, the reacting mass was cast onto a glass surface to form several thicker films (20-110 μm thick) which were cured to obtain polymers. Tensile testing was conducted on these films. This series of polymers can be elastically stretched up to approximately 68%.

In several samples, a garnet-type solid electrolyte (Li₇La₃Zr₂O₁₂ (LLZO) powder) was added into the protective layers.

The high-elasticity cross-linked polymer protective layer appears to be capable of reversibly deforming to a great extent without breakage when the lithium foil decreases in thickness during battery discharge. The elastic polymer protective layer also prevents the continued reaction between liquid electrolyte and lithium metal at the anode, reducing the problem of continuing loss in lithium and electrolyte. This also enables a significantly more uniform deposition of lithium ions upon returning from the cathode during a battery re-charge; hence, no lithium dendrite.

We claim:

1. A lithium secondary battery comprising a cathode, an anode, an elastic polymer protective layer disposed between the cathode and the anode, and a working electrolyte in ionic communication with the anode and the cathode, wherein said elastic polymer protective layer comprises a high-elasticity polymer having a thickness from 2 nm to 200 μm, a lithium ion conductivity from 10⁻⁸ S/cm to 5×10⁻² S/cm at room temperature, and a fully recoverable tensile elastic strain of at least 5% when measured without any additive or filler dispersed therein and wherein said high-elasticity polymer comprises a polymer derived from a monomer selected from the group consisting of phosphates, phosphonates, phosphonic acids, phosphorous acid, phosphites, phosphoric acids, combinations thereof, and combination thereof with phosphazenes and wherein said high-elasticity polymer is impregnated with from 0% to 90% by weight of a lithium salt, a non-aqueous liquid solvent, or a liquid electrolyte comprising a lithium salt dissolved in a non-aqueous liquid solvent.

2. The lithium secondary battery of claim 1, further comprising an ion-conducting and electrically insulating separator disposed between the elastic polymer protective layer and the cathode.

3. The lithium secondary battery of claim 1, wherein the battery is a lithium metal battery and the anode has an anode current collector but initially the anode has no lithium or lithium alloy as an anode active material supported by said anode current collector when the battery is made and prior to a charge or discharge operation of the battery.

4. The lithium secondary battery of claim 1, wherein the high-elasticity polymer further comprises a flame-retardant additive or particles of an inorganic solid electrolyte.

5. The lithium secondary battery of claim 1, wherein the polymer derived from phosphoric acid comprises chains of a polyester of phosphoric acid represented by the following structure: 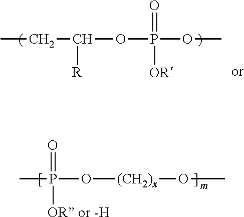
wherein 2≤x≤10, R is selected from Li, H, a methyl, ethyl, propyl, vinyl, allyl, acrylate, phenol, alkyl, aryl, or CH₂Cl, and R′ or R″ is independently selected from Li, CH₃, C₂H₅, n-C₃H₇, i-C₃H₇; n-C₄H₉, CCl₃CH₂, C₆H₅, —OH, —COOH, —O—CH₂CH₂—R′″, an alkyl, or an aryl, where R′″=—(CH₂)_{y}CH₃ and 0≤y≤10.

6. The lithium secondary battery of claim 1, wherein the monomer is selected from the group consisting of 2-alkoxy (or phenoxy)-2-oxo-1,3,2-dioxaphospholane (I) and 2-alkoxy (or phenoxy)-2-oxo-1,3,2-dioxaphosphorinane (II), derivatives thereof, and combinations thereof:

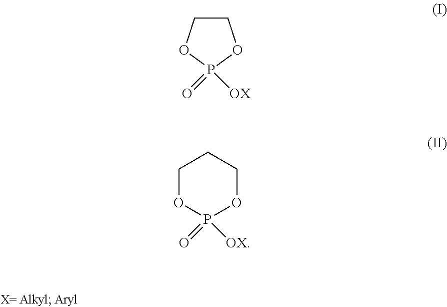

7. The lithium secondary battery of claim 1, wherein the phosphate, phosphonate, phosphonic acid, or phosphite is selected from TMP, TEP, TFp, TDP, DPOF, DMMP, DMMEMP, tris(trimethylsilyl)phosphite (TTSPi), alkyl phosphate, triallyl phosphate (TAP), a combination thereof, wherein TMP, TEP, TFP, TDP, DPOF, DMMP, and DMMEMP have the following chemical formulae: 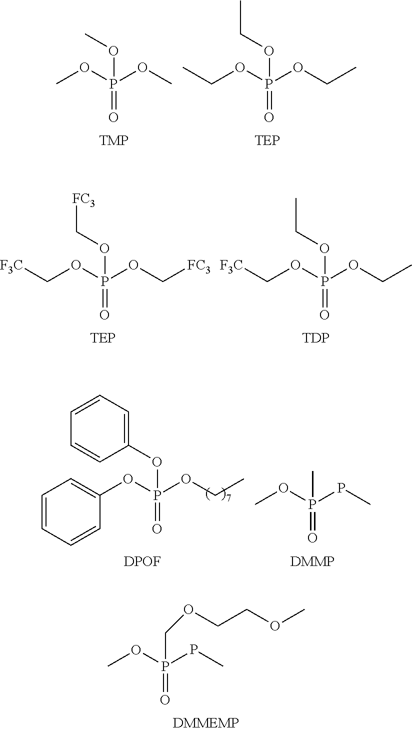
wherein an end group thereof or a functional group attached thereof comprises unsaturation for polymerization.

8. The lithium secondary battery of claim 1, wherein the monomer comprises phosphonate vinyl monomer selected from the group consisting of phosphonate bearing allyl monomers, phosphonate bearing vinyl monomers, phosphonate bearing styrenic monomers, phosphonate bearing (meth)acrylic monomers, vinylphosphonic acids, and combinations thereof.

9. The lithium secondary battery of claim 8, wherein the phosphonate bearing allyl monomer is selected from a Dialkyl allylphosphonate monomer or Dioxaphosphorinane allyl monomer;
the phosphonate bearing vinyl monomers is selected from a Dialkyl vinyl phosphonate monomer or Dialkyl vinyl ether phosphonate monomer; the phosphonate bearing styrenic monomer is selected from α-, β-, or p-vinylbenzyl phosphonate monomers; or the phosphonate bearing (meth)acrylic monomer is selected from a monomer having a phosphonate group linked to the acrylate double bond, a phosphonate groups linked to the ester, or a phosphonate groups linked to the amide.

10. The lithium secondary battery of claim 1, wherein said high-elasticity polymer comprises a network of chains that are crosslinked by a crosslinking agent to a degree of crosslinking that imparts an elastic tensile strain from 5% to 500%.

11. The lithium secondary battery of claim 10, wherein said crosslinking agent is selected from poly(diethanol) diacrylate, poly(ethyleneglycol)dimethacrylate, poly(diethanol) dimethylacrylate, polyethylene glycol) diacrylate, N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid, acrylic acid, methacrylic acid, a derivative compound of acrylic acid, a derivative compound of methacrylic acid, glycidyl functions, N,N′-Methylenebisacrylamide (MBAAm), Ethylene glycol dimethacrylate (EGDMAAm), isobomyl methacrylate, poly (acrylic acid) (PAA), methyl methacrylate, isobomyl acrylate, ethyl methacrylate, isobutyl methacrylate, n-Butyl methacrylate, ethyl acrylate, 2-Ethyl hexyl acrylate, n-Butyl acrylate, a diisocyanate, an urethane chain, a chemical derivative thereof, or a combination thereof.

12. The lithium secondary battery of claim 10, wherein the crosslinking agent comprises a compound having at least one reactive group selected from a phenylene group, a hydroxyl group, an amino group, an imino group, an amide group, an acrylic amide group, an amine group, an acrylic group, an acrylic ester group, or a mercapto group in the molecule.

13. The lithium secondary battery of claim 1, wherein the polymer is synthesized with an initiator selected from an azo compound, azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-test-butylcyclohexyl)peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, lithium hex afluorophosphate (LiPF₆), lithium borofluoride (LiBF₄), lithium hexafluoroarsenide (LiAsF₆), lithium trifluoro-methanesulfonate (LiCF₃SO₃), his-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

14. The lithium secondary battery of claim 1, wherein said elastic polymer protective layer maintains in physical contact with an anode current collector or an anode active material layer to protect said anode current collector or said anode active material layer during a battery charge or discharge.

15. The lithium secondary battery of claim 1, wherein said high-elasticity polymer further comprises from 0.1% to 95% by weight of a flame retardant additive, an inorganic filler, or both that is dispersed in, dissolved in, or chemically bonded to the high-elasticity polymer.

16. The lithium secondary battery of claim 15, wherein said flame retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

17. The lithium secondary battery of claim 15, wherein said flame retardant additive is in a form of encapsulated particles comprising the additive encapsulated by a shell of a substantially lithium ion-impermeable and liquid electrolyte-impermeable coating material, wherein said shell is breakable when exposed to a temperature higher than a threshold temperature.

18. The lithium secondary battery of claim 15, wherein said inorganic filler is selected from an oxide, carbide, boride, nitride, sulfide, phosphide, halogen compound, or selenide of a transition metal, Al, Ga, In, Sn, Pb, Sb, B, Si, Ge, Sb, or Bi, a lithiated version thereof, or a combination thereof.

19. The lithium secondary battery of claim 15, wherein said inorganic filler is selected from an inorganic solid electrolyte material in a fine powder form having a particle size from 2 nm to 30 μm.

20. The lithium secondary battery of claim 19, wherein particles of said inorganic solid electrolyte material are selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

21. The lithium secondary battery of claim 1, wherein said high-elasticity polymer further comprises an elastomer that forms a mixture, a copolymer, a semi-interpenetrating network, or a simultaneous interpenetrating network with said high-elasticity polymer wherein said elastomer is selected from natural polyisoprene, synthetic polyisoprene, polybutadiene, chloroprene rubber, polychloroprene, butyl rubber, styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, polyurethane, urethane-urea copolymer, urethane-acrylic copolymer, a copolymer thereof, a sulfonated version thereof, or a combination thereof.

22. The lithium secondary battery of claim 1, wherein said high-elasticity polymer further comprises from 0.1% to 70% by weight of a lithium ion-conducting additive.

23. The lithium secondary battery of claim 22, wherein said lithium ion-conducting additive comprises a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

24. The lithium secondary battery of claim 1, wherein the high-elasticity polymer forms a mixture, a blend, a copolymer, a semi-interpenetrating network, or a simultaneous interpenetrating network with a lithium ion-conducting polymer selected from poly(ethylene oxide) (PEO), Polypropylene oxide (PPO), poly(acrylonitrile) (PAN), poly(methyl methacrylate) (PMMA), poly(vinylidene fluoride) (PVdF), Poly bis-methoxy ethoxyethoxide-phosphazene, Polyvinyl chloride, Polydimethylsiloxane, poly(vinylidene fluoride)-hexafluoropropylene (PVDF-HFP), a sulfonated derivative thereof, or a combination thereof.

25. The lithium secondary battery of claim 1, wherein said working electrolyte is selected from an organic liquid electrolyte, ionic liquid electrolyte, polymer gel electrolyte, solid-state electrolyte, quasi-solid electrolyte having a lithium salt dissolved in an organic or ionic liquid with a lithium salt concentration higher than 2.0 M, hybrid or composite electrolyte, or a combination thereof.

26. The lithium secondary battery of claim 1, wherein the battery is a lithium-ion battery and the anode has an anode current collector and a layer of an anode active material supported by said anode current collector, wherein the anode active materials is selected from the group consisting of: (a) silicon (Si), germanium (Ge), tin (Sn), lead (Pb), antimony (Sb), phosphorus (P), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium titanium niobium oxide, lithium-containing titanium oxide, lithium transition metal oxide, ZnCo₂O₄; (f) carbon or graphite particles (g) prelithiated versions thereof; and (h) combinations thereof.

27. The lithium secondary battery of claim 1, wherein said cathode comprises a cathode active material selected from an inorganic material, an organic material, a polymeric material, or a combination thereof.

28. The lithium secondary battery of claim 27, wherein said inorganic material, as a cathode active material, is selected from sulfur, selenium, a metal oxide, metal phosphate, metal silicide, metal selenide, metal sulfide, or a combination thereof.

29. The lithium secondary battery of claim 27, wherein said inorganic material is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

30. The lithium secondary battery of claim 27, wherein said inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

31. The lithium secondary battery of claim 28, wherein said metal oxide or metal phosphate is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

32. The lithium secondary battery of claim 27, wherein the cathode active material comprises lithium nickel manganese oxide (LiNiₐMn₂₋₁O₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

33. A process for manufacturing the elastic polymer protective layer of claim 1, the process comprising (A) dispersing an inorganic solid electrolyte particles in a liquid reactive mass of an elastic polymer precursor to form a reactive slurry wherein said elastic polymer precursor comprises a monomer, oligomer, or reactive polymer derived from a monomer selected from the group consisting of phosphates, phosphonates, phosphonic acids, phosphorous acid, phosphites, phosphoric acids, combinations thereof, and combination thereof with phosphazenes; (B) dispensing and depositing a layer of said liquid reactive mass or slurry onto a solid substrate surface; and (C) polymerizing and/or curing said reactive mass or slurry to form said elastic polymer protective layer.

34. The process of claim 33, wherein said solid substrate is an anode current collector, an anode active material layer, a separator layer, or a cathode active material layer.

35. The process of claim 33, which is a roll-to-roll process wherein said step (B) comprises (i) continuously feeding a layer of said solid substrate from a feeder roller to a dispensing zone where said reactive mass is dispensed and deposited onto said solid substrate to form a continuous layer of said reactive mass; (ii) moving said layer of the reactive mass into a reacting zone where the reactive mass is exposed to heat, ultraviolet light, or high-energy radiation to polymerize and/or crosslink said reactive mass to form a continuous layer or roll of elastic polymer; and (iii) collecting said elastic polymer on a winding roller.

36. The process of claim 35, further comprising cutting and trimming said layer or roll of elastic polymer into one or multiple pieces of elastic polymer protective layers.

37. The process of claim 33, further comprising a step of combining an anode, said elastic polymer protective layer, a working electrolyte, and a cathode electrode to form a lithium battery.

38. The process of claim 33, wherein, in addition to the inorganic solid electrolyte particles, a flame retardant additive is also dispersed in the liquid reactive mass of the elastic polymer precursor.

39. An elastic and flame retardant composite layer, wherein said elastic and flame retardant composite layer comprises a high-elasticity polymer and from 0.1% to 95% by weight of a flame retardant additive dispersed in, dissolved in, or chemically bonded to the high-elasticity polymer, wherein said elastic composite separator has a thickness from 10 nm to 200 μm and a lithium ion conductivity from 10⁻⁸ S/cm to 5×10⁻² S/cm at room temperature and said high elasticity polymer has a fully recoverable tensile strain greater than 5% when measured without any additive dispersed therein and wherein said high-elasticity polymer is derived from a monomer selected from the group consisting of phosphates, phosphonates, phosphoric acids, phosphorous acid, phosphites, phosphoric acids, combinations thereof, and combination thereof with phosphazenes.
